(19) United States
(12) Patent Application Publication
(10) Pub. No.: US 2004/0248317 A1
(43) Pub. Date: Dec. 9, 2004

(54) Glycopeptide identification and analysis

(76) Inventors: Sajani Swamy, Orleans (CA); Navdeep Jaitly, Montreal (CA); Alexandra Furtos-Matei, Cote St. Luc (CA); Paul Edward Kearney, Montreal (CA); Pierre Thibault, IIe Bizard (CA)

Correspondence Address: CLARK & ELBING LLP, 101 FEDERAL STREET, BOSTON, MA, 02110, US

(21) Appl. No.: 10/751,750

(22) Filed: Jan. 5, 2004

Related U.S. Application Data
(60) Provisional application No. 60/437,832, filed on Jan. 3, 2003.

(51) Int. Cl. G01N 24/00

(52) U.S. Cl. 436/173

(57) ABSTRACT

The invention described herein is a tool developed for the analysis of proteomic mass spectrometry (MS) data to identify and characterize glycoproteins. The tool is designed to perform four main tasks, separately, or as needed: optimize the selection of glycopeptides for MS/MS, identify glycopeptide spectra from MS/MS data, characterize the sugar moieties of identified glycopeptide spectra, and match the glycosylated precursor to its parent protein. The design and implementation for each of these components is described in more depth in this patent application.

### CROSS-REFERENCE TO RELATED APPLICATONS

This application claims benefit of U.S. provisional patent application 60/437,832, filed Jan. 3, 2003; the disclosure of which is hereby incorporated by reference.

### FIELD OF THE INVENTION

The invention relates to the fields of mass spectrometry, bioinformatics, and biochemistry. In particular, the invention relates to methods of detecting glycopeptides. More specifically, the invention relates to mass spectrometry and methods of detecting glycopeptides from MS-MS spectra.

### BACKGROUND OF THE INVENTION

Genomic and proteomic research efforts in recent years have vastly improved our understanding of the molecular basis of life. In particular, it is increasingly clear that precise temporal and spatial patterns of expression of an organism's biomolecules are responsible for life's processes—processes occurring in both health and in sickness. Science has progressed from understanding how genetic defects cause hereditary disorders, to an understanding of the importance of the interaction of multiple genetic defects together with environmental factors in the etiology of complex medical disorders, such as cancer. In the case of cancer, scientific evidence demonstrates the key causative roles of altered expression of, and multiple defects in, several pivotal genes and their protein products. Other complex diseases have similar molecular underpinnings. Methods that permit efficient and rapid identification and quantification of biomolecule expression from biological samples are necessary to provide the best possible chance to determine such correlations. For example, proteomic data can reflect the true expression levels of functional molecules and their post-translational modifications, which cannot be accurately predicted from other data types such as gene expression profiling.

Mass spectrometry (MS) itself is a method of choice for analyzing complex mixtures of molecules, such as the contents of cells or cellular components, to produce proteomic data. When combined with appropriate methods of chromatography to allow separation and purification of proteins, mass spectrometry provides a start point for producing and analyzing data for the identification and quantification of proteins, and for patterns that liken or distinguish different samples. At its most basic, mass spectrometry produces data about the masses of proteins, and their intensities (ion counts) for a particular scan. Fragmentation patterns for specific molecules can also be produced by MS/MS (tandem mass spectrometry), which can be used to further identify the molecules in the initial scan. In the case of polymers such as DNA or proteins, secondary efforts are generally required to obtain sequence information from the fragmentation patterns, to determine the source protein from the sequence information, and to couple sequence/identity information to quantification data.

One problematic class of biomolecules of particular interest, the study of which has been approached with mass spectrometric analysis, is glycopeptides. Glycosylation of proteins is a common post-translational modification with an estimated greater than half of all proteins glycosylated, and is crucial for many cellular processes. Aberrant glycosylation profiles are key markers for diseases such as breast cancer and rheumatoid arthritis (Varki et al. (1999) Essentials of Glycobiology. Cold Springs Harbor Laboratory Press, La Jolla, Calif.). Increasingly, mass spectrometry is preferred over traditional methods of carbohydrate analysis, which are often laborious and unsuitable for low abundance glycoproteins, because of its superior sensitivity to other spectroscopic methods. Generally, classical methods of glycan analysis are insensitive at the levels typically separated by 2-D PAGE, but mass spectrometry has been used to characterize oligosaccharide attributes on picomole amounts of protein, and sensitivities run into the femtomolar range. However, the low abundance and hindered ionization (as compared to peptides, which are more easily protonated) seen with many glycopeptides can prevent automated selection for MS/MS, as can selection methods based on peptide identification by mass-to-charge ratio. Without fragmentation spectra data obtained by MS/MS, more specific characterization of glycopeptides, including the identification of their native (unglycosylated) peptides, is greatly hindered.

When subject to mass spectrometry with collision-induced dissociation (CID), glycopeptides exhibit a characteristic fragmentation pattern which can be detected by visual inspection. Given the high volume of data output from proteome studies today, manually searching for glycopeptides is an impractical task. In addition, once identified, the elucidation of the glycan structure is difficult as carbohydrate structures are often highly complex. Protein glycosylation can drastically alter protein function and structure. Identification of the native peptides—the peptide portions of glycopeptides—can require additional laborious analysis and manipulation, such as separation of the peptide and carbohydrate components of the fragmentation spectra. A tool is available for automated analysis of carbohydrate structures, StrOligo (Ethier et al. (2002) Rapid Communications in Mass Spectrometry 16: 1743-1754), which interprets derivatized complex N-linked oligosaccharides from tandem mass spectra. When presented with the fragmentation pattern of a carbohydrate, StrOligo suggests possible structures for the sugar. However, StrOligo, operates only on the spectra of carbohydrates and not of glycopeptides, and thus requires that any glycopeptide analyzed be treated chemically prior to analysis to be able to structurally characterize the sugar moiety.

The chemical treatment of glycoproteins provides problems for both structural analysis and identification. The pre-treatment of samples with chemicals and/or deglycosylation to enable the analysis of glycoproteins may require a large amount of sample. Since many biologically interesting glycoproteins are expressed in low abundance, however, chemical pre-treatment of glycoproteins is generally not feasible for their analysis. In some cases, glycopeptides are also isolated and analyzed separately from the bulk of a sample's peptides, resulting in loss of sample and loss of peptide coverage. Despite both the importance of glycosylation itself, and the importance of identifying the native peptides of glycopeptides (in proteomics the comprehensive identification of peptides from a biological sample can be critical to proper protein identification, such as through increased peptide coverage, and is also critical to protein quantitation, and the comparability of samples), there exists little technology for large scale glycoproteomic research, and limited research is performed in this area.

Thus, there is a need for methods of identifying glycopeptides in biological samples analyzed using mass spectrometry that do not require chemical modification of the glycopeptides or isolation and analysis separate from unglycosylated peptides. And, given the high volume of data output from proteome studies today, manually searching mass spectrometry data for glycopeptides is impractical, whether from survey scans or MS/MS fragmentation spectra. Coupling identified spectra with structural analysis could provide additional time savings and further identification. The ability to select glycopeptides for MS/MS based on their identification in survey scans is also desirable, as is the identification/quantitation of the naked peptide and the corresponding protein or proteins it was derived from. The present invention addresses these needs and further provides other related advantages.

### BRIEF SUMMARY OF THE INVENTION

To address these needs and render glycopeptide identification and analysis feasible for high throughput proteomics, as described herein, the inventors have developed the N-GIA tool for the analysis of mass spectrometry (MS) data to identify and characterize glycoproteins. The tool is particularly used for analysis of N-linked glycoproteins, as the more rigid structure of N-linked glycopeptides and their attachment to a defined protein attachment sequon, NXS/T, facilitate analysis over O-linked glycopeptides. However, one skilled in the art could easily adapt the methods herein for analysis of O-linked glycopetides, or glycopeptides in general.

The tool is designed to perform four practical tasks, separately or in combination: optimize the selection of glycopeptides for MS/MS, identify glycopeptide spectra from MS/MS data, characterize the sugar moieties of identified glycopeptide spectra, and match a glycosylated precursor to its parent protein. Computer procedures for performing the tasks are described herein as “modules.” The tool itself, N-GIA, comprises one or more of the modules, additional procedures for interactions between and among two or more modules, as well as a user interface and related procedures. FIG. 2 shows a flowchart illustrating modules of an exemplary N-GIA tool. The flowchart is presented for the purpose of illustrating, not limiting, the methods of the invention.

The tool may also be combined with other modules or programs, such as MIPS (U.S. patent application Ser. No. 10/293,076, U.S. Patent Publication Number 2003/0129760, published on Jul. 10, 2003) or Constellation Mapping (U.S. patent application Ser. No. 60/428,731), the contents of which applications are incorporated by reference, for example to determine an abundance for a biomolecule in a biological sample.

The invention features a computer implemented method for determining glycoforms in mass spectrometry survey scan data. In general, the method for determining glycoforms in mass spectrometry survey scan data generally includes the steps of providing a biological sample containing a plurality of biomolecules; generating a plurality of ions of the biomolecules; performing mass spectrometry measurements on the plurality of ions, thereby obtaining ion count peaks for the biomolecules; and, identifying distributions of glycoform ion count peaks by monosaccharide differences, thereby determining the presence of glycoforms in the biological sample. Determined glycoforms may be specifically selected for further analysis, such as through selection for MS-MS acquisition.

The invention further features a computer implemented method for identifying glycopeptide spectra from MS/MS data. The computer implemented method generally includes the steps of inputting mass spectrometry data comprising ion counts for a plurality of biomolecules; assessing one or more MS/MS spectra for the presence of oxonium ions, a low peak density area, and monosaccharide loss; scoring the spectra; comparing the spectra scores to a glycosylation threshold, and classifying spectra as glycopeptide spectra or not based on the results of the comparison of spectra scores to a glycosylation threshold.

The invention further features a computer implemented method for determining the most likely naked peptide for a glycopeptide spectrum from a group of candidate naked peptides, with steps generally comprising: inputting a group of candidate naked peptides for a glycopeptide spectrum; applying theoretical sugar fragments to the candidate naked peptides; determining correlation scores for the resultant candidate glycopeptides; determining the highest scoring match from the group of candidate glycopeptides, from which the carbohydrate portion indicates the optimal sugar structure, and the peptidic portion indicates the most likely naked peptide.

In another aspect, the invention features a computer-readable memory that includes a program for performing said computer implemented methods including computer code that receives appropriate input mass spectrometry data and performs the steps of the invention.

In yet another aspect, the invention features a computer system for performing said computer implemented methods including a processor and a memory coupled to the processor, the memory encoding one or more programs, the one or more programs causing the processor to perform said methods.

In another aspect, the invention features a method for displaying information to a user utilized or generated by the methods of the invention, but not limited to exclusively thereto. In one embodiment, the method further includes storing information utilized or generated by the methods of the invention, but not limited exclusively thereto, in a memory.

In preferred embodiments, mass spectrometry measurements are obtained to gather structural or sequence information on the naked peptide of a glycopeptide. The methods and systems include a computer procedure that assigns the ion to the protein identified from a database. The methods and systems of the invention further feature the use of a computer procedure to identify a protein comprising the sequence of the ion from a database. Exemplary procedures include Mascot, Protein Lynx Global Server, SEQUEST/TurboSEQUEST, PEPSEQ, SpectrumMill, or Sonar MS/MS. Exemplary databases that are searched using such procedures include the Genbank, EMBL, NCBI, MSDB, SWISS-PROT, TrEMBL, dbEST, or Human Genome Sequence database.

Other features and advantages of the invention will be apparent from the following drawings and detailed description, and from the claims.

### BRIEF DESCRIPTION OF THE DRAWINGS

FIG. 1. This figure illustrates an exemplary embodiment of a computer system of this invention. Computer system 2 includes internal and external components. The internal components include a processor 4 coupled to a memory 6. The external components include a mass-storage device 8, e.g., a hard disk drive, user input devices 10, e.g., a keyboard and a mouse, a display 12, e.g., a monitor, and usually, a network link 14 capable of connecting the computer system to other computers to allow sharing of data and processing tasks. Programs are loaded into the memory 6 of this system 2 during operation. These programs include an operating system 16, e.g., Microsoft Windows, which manages the computer system, software 18 that encodes common languages and functions to assist programs that implement the methods of this invention, and software 20 that encodes the methods of the invention in a procedural language or symbolic package. Languages that can be used to program the methods include, without limitation, Visual C/C⁺⁺ from Microsoft.

FIG. 2 shows a flowchart for a Glycopeptide Identification Tool. Arrows are to emphasize that analysis may take place in several possible orders and at several possible points in the data generation process, and may not necessarily rely on all the available modules. In particular, the Sugar Structure Identification Module and the Protein ID Module may be driven simultaneously from the same MS/MS spectrum and may rely on common calculations to achieve their differing ends, hence they are further grouped into a single “Glycan Analysis Module.”

FIG. 3 shows A) some common monosaccharides and their masses and B) provides an exemplary set for higher animals and humans, six of which are common and 2 are rare. Masses in B) are for the neutral monosaccarides, in A) for the protonated form.

FIG. 4. Schematic of N-linked glycopeptide fragmentation. A) Upon Collision-Induced Dissociation (CID), the more labile carbohydrate appendage of the glycopeptide typically dissociates, leaving a backbone peptide (the “naked peptide”) with the first N-acetylglucosamine residue (GlcNAc) still attached to the asparagine (Asn) in the peptide sequence (squiggly lines) that is the site of glycosylation, with otherwise full fragmentation of the carbohydrate moiety. Various monosaccharides represented by geometric shapes (squares, rectangles, star, etc.). Carbohydrate oxonium ions generated by the fragmentation are generally stable carbocations and have characteristic m/z ratios that can be used as specific markers for glycopeptides, optimally in combination with other such diagnostic markers. The peptide moiety itself typically does not fragment, preventing direct identification of its sequence. Asparagine is represented by “N” in one-letter code for amino acids, and glycosylation at an asparagine is called “N-linked glycosylation”. B) A partial glycopeptide fragmentation event is shown for comparison. Partial fragmentation products can allow the determination of the carbohydrate structure. Partial fragment products containing the naked peptide generally produce the peaks in the high m/z range of the spectrum spaced by differences corresponding to combinations of lost saccharides (more concisely referred to as “monosacchraride loss”), while oxonium ions as free carbohydrates tend to fall in the low m/z range, with low peak density between these two regions as might be expected.

FIG. 5. A typical glycopeptide spectrum. In this spectrum, the three main features of glycopeptide ESI-MS/MS spectra are illustrated. In the low m/z range, oxonium ion peaks at m/z 204 (HexNAc) and 366 (HexNAcHex) are observed. In addition, an area of low peak density is present in the midrange of the spectrum, while the high m/z range contains peaks separated by various monosaccharide combinations (pentasaccharide core fragmentation fingerprint—peaks differing by m/z's indicative of hexose (HexNAc2—three peaks (0, 1, 2) roughly 2=base molecule plus two hexose units, 1=base molecule plus one hexose unit, 0=base molecule) and mannose (Man3—four peaks (0, 1, 2, 3) roughly 3=base molecule plus three mannose units, 2=base molecule plus two mannose units, 1=base molecule plus one mannose unit, 0=base molecule) are illustrated). The X-axis indicates the m/z, while the Y-axis indicates relative intensity.

FIG. 6. Example of diagnostic peak score post-filtering. The X-axis indicates the m/z, while the Y-axis (not depicted) indicates relative intensity. This glycopeptide spectrum contains a high intensity peak at m/z 204.13, the same m/z as an HexNAc oxonium ion fragment. However, this spectrum represents a peptide. The 204.13 peak in this case represents a y2-tryptic fragment of the GK di-peptide. The high density of non-diagnostic peaks in this low-mid m/z range of the spectrum is used to reduce the confidence level of the diagnostic peak score. In this case, this spectrum was correctly classified as a false positive after peak score filtering.

FIG. 7. There are different features particular to the spectra of different types of biomolecules. A) A glycopeptide spectrum. B) A spectrum that is neither from a glycopeptide, nor a peptide. C) A peptide spectrum.

FIG. 8. Some oxonium ions commonly seen in glycopeptide spectra.

FIG. 9. A typical glycopeptide spectrum. In this spectrum, the three main features of glycopeptide ESI-MS/MS spectra are illustrated. In the low m/z range, several oxonium ion peaks such as m/z 204 (HexNAc) and 366 (HexNAcHex) are observed in red. In addition, differential peak densities are observed throughout the spectrum; an area of low peak density is observed in the mid-range of the spectrum. Peaks separated by various monosaccharide combinations are also illustrated in the spectrum in yellow.

FIG. 10. In order to establish a glycosylation score threshold, the accuracy of classification at thresholds at 0.1 intervals was examined. For each glycosylation score threshold, the hits returned at or above the threshold were manually verified as being true or false positives. These values were combined with the number of glycopeptides missed at this threshold (false negatives) to produce a profile describing the glycopeptide distribution in terms of false positives, true positives and false negatives for the threshold score. Depicted are profiles for threshold scores in the range of 0.6 to 1.4. The profiles for threshold scores below 0.8 and above 1.2 were shown not to vary significantly. The absolute count of each type of hit for a threshold score is also labeled for each peptide class. As the glycosylation score thresholds increase, there is an increase in the number of false negatives. The opposite trend is observed for false positives. These trends illustrate that in general, spectra that receive scores above 1.2 represent glycopeptides, and those that receive scores below 0.8 are non-glycosylated peptides. Hits in the 0.9-1.1 range can be classified as glycopeptides with less confidence, as there is a mixture of false negatives and false positives for these scores. The results illustrated suggest that 0.9 is an optimal glycosylation score threshold as it contains the best ratio of false positive to false negative results (assuming false positives to be preferable to false negatives).

FIG. 11. Analysis of the Glycopeptide Identification Module. The Glycopeptide Identification module was tested on 3 different sets of data: Validated glycopeptides (purple bars), peptides (white bars), and random spectra (light blue bars). Plots were created demonstrating a) The distribution of glycosylation scores in the 3 data sets and b) the distribution of peptide coverage scores in the 3 data sets. The peptide coverage score is a measure of the “peptidic quality” of a spectrum and indicates the percentage of a spectrum that is spanned by amino acids and thus the likelihood of representing a peptide spectrum. Peptide coverage scores greater than 100 generally represent peptide spectra. It would be expected that spectra receiving high glycopeptide scores would receive low peptide coverage scores and vice-versa.

FIG. 12. This figure illustrates the fundamental difference between peptide and carbohydrate fragmentation. Potential fragmentation points are illustrated with double-ended arrows. A) The linear peptide molecule fragments at the peptide bonds and creates b- or y-type ions. Peptides have as many possible breakage points as there are residues and for any one type of fragment product (i.e. b- vs. y-ions), the number of peaks produced is at most the same as the number of bonds. The branched structure of carbohydrates as illustrated in B) however, has potential fragmentation points all along the structure. Since there are 2 branches for the structure in B, there can be 2 simulataneous fragmentation events, one along each branch resulting in a much bigger set of possible peaks.

FIG. 13. The number of fragments derived from carbohydrate CID can be quite large due to the need to consider fragmentation products across branches. In this schematic, two CID species are illustrated. Species I and II represent unique masses generated by partial fragmentation across the two branches. Thus, in addition to having to consider fragmentation products along each path, sub-tree combinations must also be examined.

FIG. 14. This figure illustrates glycan MS/MS ion searching using the Path Model for glycan fragmentation. Peaks missing in the experimental spectrum are drawn in dashed lines in the theoretical spectrum. The peaks can also appear in their charge states throughout the spectrum. In the experimental spectrum the +2 m/z peaks of the glycan peaks are illustrated in green. The number of fragments produced is proportional to the number of number of monosaccharides in the structure, regardless of topology of the glycan, decreasing the likelihood of random peak matches, while still including peaks likely to appear to be matched to the experimental spectrum.

FIG. 15. The determination of the naked peptide peak enables the matching of the glycopeptide to its parent protein. In the example illustrated in this figure, the glycan shown is fragmented using the Path Model of glycan fragmentation. These peaks are subsequently overlaid upon experimental glycopeptide spectra and scored starting from various high intensity peaks in the high m/z range, each a naked peptide candidate. From the highest scoring match, the naked peptide and glycan are determined. The naked peptide mass can then used to match the glycopeptide to its parent protein using Peptide Mass Fingerprinting (PMF) techniques.

FIG. 16. Results for complex data. nm=number of matched glycan peaks, no=number of observed glycan peaks, ne=number of expected peaks from the fragmentation model.

FIG. 17. Results for oligomannose data. nrn=number of matched glycan peaks, no=number of observed glycan peaks, ne=number of expected peaks from the fragmentation model.

FIG. 18. This figure illustrates the ability of the software to assist in differential glycopeptide analysis. Part A illustrates the MS/MS spectrum of a differentially expressed glycopeptide at m/z 1021.16. Upon the examination of the survey scans of the tumor and normal tissues at this m/z range, parts B and C respectively, the intensity of the peak at 1021 was found to be much more intense in the survey scan of the tumor as opposed the normal sample and thus differentially expressed. Using a Protein ID module, the glycopeptide was mapped to the Carcinoembryonic Antigen (CEA5 HUMAN), a known protein marker for cancer.

### DETAILED DESCRIPTION OF THE INVENTION

By “biomolecule” is meant any organic molecule that is present in a biological sample, including peptides, polypeptides, proteins, post-translationally modified proteins and peptides (e.g., glycosylated, phosphorylated, or acylated peptides), oligosaccharides, polysaccharides, lipids, nucleic acids, and metabolites. Exemplary biomolecules useful in the methods of the invention include any organic molecule that is present in a biological sample, e.g., peptides, polypeptides, proteins, post-translationally modified peptides (e.g., glycosylated, phosphorylated, or acylated peptides), oligosaccharides and polysaccharides, lipids, nucleic acids, and metabolites.

By “biological sample” (or “sample”) is meant any solid or fluid sample obtained from, excreted by, or secreted by any living organism, including single-celled micro-organisms (such as bacteria and yeasts) and multicellular organisms (such as plants and animals, for instance a vertebrate or a mammal, and in particular a healthy or apparently healthy human subject or a human patient affected by a condition or disease to be diagnosed or investigated). A biological sample may be a biological fluid obtained from any location (such as blood, plasma, serum, urine, bile, cerebrospinal fluid, aqueous or vitreous humor, or any bodily secretion), an exudate (such as fluid obtained from an abscess or any other site of infection or inflammation), or fluid obtained from a joint (such as a normal joint or a joint affected by disease such as rheumatoid arthritis). Alternatively, a biological sample can be obtained from any organ or tissue (including a biopsy or autopsy specimen) or may comprise cells (whether primary cells or cultured cells) or medium conditioned by any cell, tissue or organ. If desired, the biological sample is subjected to preliminary processing, including preliminary separation techniques. For example, cells or tissues can be extracted and subjected to subcellular fractionation for separate analysis of biomolecules in distinct subcellular fractions, e.g., proteins or drugs found in different parts of the cell. A sample may be analyzed as subsets of the sample, e.g., bands from a gel.

By “fraction” is meant a portion of a separation. A fraction may correspond to a volume of liquid obtained during a defined time interval, for example, as in LC (liquid chromatography). A fraction may also correspond to a spatial location in a separation such as a band in a separation of a biomolecule facilitated by gel electrophoresis.

As used herein, “protein”, “peptide”, or “polypeptide” refers any of numerous naturally occurring, or synthetically or recombinantly produced, some times extremely complex (such as an enzyme, antibody, or multi-subunit protein complex) substances that consist of a chain of four or more amino acid residues joined by peptide bonds. The chain may be linear, branched, circular, or combinations thereof. Intra-protein bonds also include disulfide bonds. Protein molecules contain the elements carbon, hydrogen, nitrogen, oxygen, usually sulfur, and occasionally other elements (such as phosphorus or iron). Herein, “protein” (and its given equivalent terms) is also considered to encompass fragments, variants and modifications (including, but not limited to, glycosylated (i.e. glycopeptides, glycoproteins), acylated, myristylated, and/or phosphorylated residues) thereof, including the use of amino acid analogs, as well as non-proteinacious compounds intrinsic to enzymatic function, such as co-factors, or guide templates (for example, the template RNA associated with proper telomerase function).

By “precursor” is meant a biomolecule, e.g., a potential peptide or protein or one of unknown sequence or identity. Generally it refers to potential peptides in mass spectrometry survey scan data prior to secondary identification efforts, such as being sequenced by MS-MS. “Precursors” are frequently identified by comparing their masses or their retention times. Such retention times may be experimental or theoretical. Theoretical retention times are frequently corrected, where one or more internal standards is used to make retention times comparable between samples. Predicted retention times may be used to seek precursors within a scan. “Precursor” is frequently used interchangeably with “peptide,” and it may be used to distinguish individual constituent peptides from full-length proteins.

By “scan” is meant a mass spectrum from a single sample. Each fraction of a separation that is measured results in a scan. If a biomolecule is located in more than one fraction analyzed, then the mass spectrum for the biomolecule is present in more than one scan.

By “uncharged mass” is meant the mass of the neutral charge state of the biomolecule or a fragment thereof from which an ion is generated.

### N-GIA

The inventors have produced N-GIA, a glycosylation tool, an embodiment of a process described herein as comprising a functional module or modules, their interactions, interface, and output, which relate to the identification and characterization of glycopeptides in biological samples analyzed by mass spectrometry (MS). The tool does not require that the glycopeptides themselves or their peptidic or carbohydrate moieties to have been labeled or derivatized.

Biological Samples

Using the methods of the invention, virtually any biological sample is useful in the methods of the invention, including, without limitation, any solid or fluid sample obtained from, excreted by, or secreted by any living organism, including single-celled micro-organisms (such as bacteria and yeasts) and multicellular organisms (such as plants and animals, for instance a vertebrate or a mammal, and in particular a healthy or apparently healthy human subject or a human patient affected by a condition or disease to be diagnosed or investigated). A biological sample may be a biological fluid obtained from any location (such as blood, plasma, serum, urine, bile, cerebrospinal fluid, aqueous or vitreous humor, or any bodily secretion), an exudate (such as fluid obtained from an abscess or any other site of infection or inflammation), or fluid obtained from a joint (such as a normal joint or a joint affected by disease such as rheumatoid arthritis). Alternatively, a biological sample can be obtained from any organ or tissue (including a biopsy or autopsy specimen) or may comprise cells (whether primary cells or cultured cells) or medium conditioned by any cell, tissue, or organ. If desired, the biological sample is subjected to preliminary processing, including preliminary separation techniques. For example, cells or tissues can be extracted and subjected to subcellular fractionation for separate analysis of biomolecules in distinct subcellular fractions, e.g., proteins or drugs found in different parts of the cell. Such exemplary fractionation methods are described in De Duve ((1965) J. Theor. Biol. 6: 33-59).

When analyzing proteins, a biological sample, if desired, is purified to reduce the amount of any non-peptidic materials present. Moreover, if desired, protein-containing samples are cleaved to produce smaller peptides for analysis. Cleavage of the peptides is generally accomplished enzymatically, e.g., by digestion with trypsin, elastase, or chymotrypsin, or chemically, e.g., by cyanogen bromide. The cleavage at specific locations in a protein allows the prediction of the masses of the smaller peptides produced if the sequences of these peptides are known.

Separation of Biomolecules

A wide variety of techniques for separating any of the aforementioned biomolecules are well known to those skilled in the art (see, for example, Laemmli (1970) Nature 227: 680-685; Washburn et al. (2001) Nat. Biotechnol. 19: 242-7; Schagger et al. (1991) Anal. Biochem. 199: 223-31) and may be employed according to the present invention.

In one application, the methods of the invention are used to study complex mixtures of proteins. By way of example, mixtures of proteins may be separated on the basis of isoelectric point (e.g., by chromatofocusing or isoelectric focusing), of electrophoretic mobility (e.g., by non-denaturing electrophoresis or by electrophoresis in the presence of a denaturing agent such as urea or sodium dodecyl sulfate (SDS), with or without prior exposure to a reducing agent such as 2-mercaptoethanol or dithiothreitol), by chromatography, including LC, FPLC, and HPLC, on any suitable matrix (e.g., gel filtration chromatography, ion exchange chromatography, reverse phase chromatography, or affinity chromatography, for instance with an immobilized antibody or lectin or immunoglobins immobilized on magnetic beads), or by centrifugation (e.g., isopycnic centrifugation or velocity centrifugation).

In some cases, two different peptides may have the same mass within the resolution of a mass spectrometer, rendering determination of spectra for those two peptides difficult. Separating the peptides before analysis by mass spectrometry allows for the resolution of the abundances of two peptides with the same mass. Although many spectra for the fractions of the separation may then be obtained, these spectra typically have a reduced number of ion peaks from the peptides, which simplifies the analysis of a given spectrum.

In one embodiment, a mixture of proteins is separated by 1D gel electrophoresis according to methods known in the art. The lane containing the separated proteins is excised from the gel and divided into fractions. The proteins are then digested enzymatically. The peptides produced in each fraction are then analyzed by mass spectrometry. In another embodiment, peptides are separated by 2D gel electrophoresis according to methods known in the art. The proteins are then digested enzymatically, and the digested peptides produced in each fraction are then excised and analyzed by mass spectrometry. In still another embodiment peptides are separated by liquid chromatography (LC) by methods known in the art, including, but not limited to, multidimensional LC. LC fractions may be collected and analyzed or the effluent may be coupled directly into a mass spectrometer for real-time analysis. LC may also be used to separate further the fractions obtained by gel electrophoresis. Recording the retention time (RT) of a peptide in LC enables the identification of that peptide in multiple fractions. This identification is typically useful for obtaining an accurate abundance. In any of the above embodiments, a given peptide may be present in more than one fraction depending on how the fractions were obtained.

Mass Spectrometry

Exemplary methods for analyzing biomolecules using mass spectrometry techniques are well known in the art (see Godovac-Zimmermann et al. (2001) Mass Spectrom. Rev. 20: 1-57; Gygi et al. (2000) Proc. Natl. Acad. Sci. U.S.A. 97: 9390-9395).

In applications involving peptides, the peptides are ionized, e.g., by electrospray ionization, before entering the mass spectrometer, and different types of mass spectra, if desired, are then obtained. The exact type of mass spectrometer is not critical to the methods disclosed herein. For example, in a survey scan, mass spectra of the charged peptides in a sample are recorded. Furthermore, the amino acid sequences of one or more peptides may be determined by a suitable mass spectrometry technique, such as matrix-assisted laser desorption/ionization combined with time-of-flight mass analysis (MALDI-TOF MS), electrospray ionization mass spectrometry (ESI MS), or tandem mass spectrometry (MS/MS). In a MS/MS scan, specific ions detected in the survey scan are selected to enter a collision chamber. The ability to define the ions for MS/MS allows data to be acquired for specific precursors, while potentially excluding other precursors. The ions may be defined by a predetermined list or by a query. Lists may be inclusion lists (i.e., ions on the list are subjected to MS/MS) or exclusion (i.e., ions on the list are not subjected to MS/MS). The series of fragments that is generated in the collision chamber is then analyzed again by mass spectrometry, and the resulting spectrum is recorded and may be used to identify the amino acid sequence of the particular peptide. This sequence, together with other information such as the peptide mass, may then be used, e.g., to identify a protein. The ions subjected to MS/MS cycles may be user defined or determined automatically by the spectrometer.

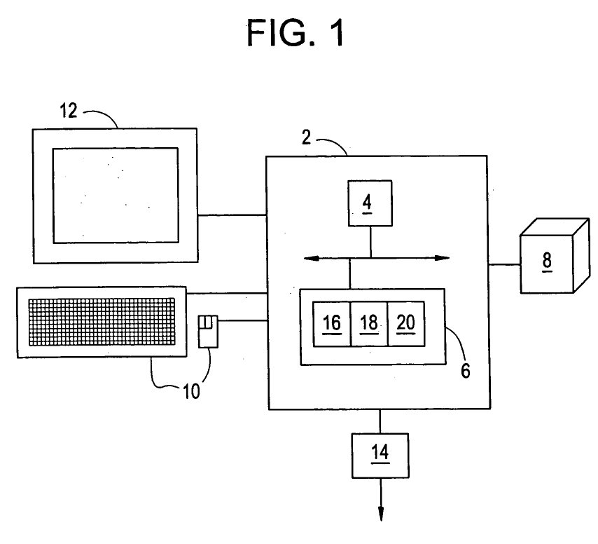

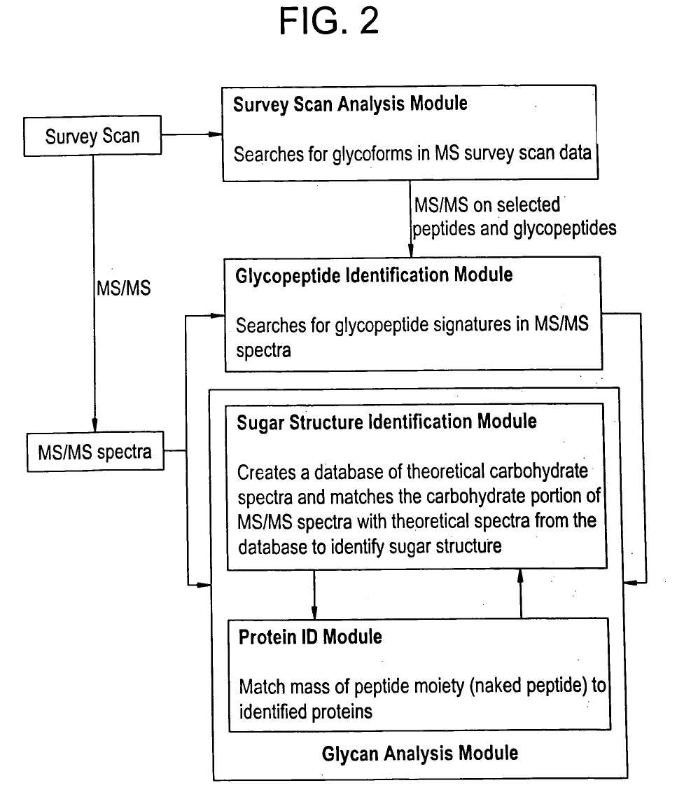

The methods described herein are implemented using virtually any computer system and according to the following exemplary programs. FIG. 1 shows an exemplary computer system. Computer system 2 includes internal and external components. The internal components include a processor 4 coupled to a memory 6. The external components include a mass-storage device 8, e.g., a hard disk drive, user input devices 10, e.g., a keyboard and a mouse, a display 12, e.g., a monitor, and usually, a network link 14 capable of connecting the computer system to other computers to allow sharing of data and processing tasks. Programs are loaded into the memory 6 of this system 2 during operation. These programs include an operating system 16, e.g., Microsoft Windows, which manages the computer system, software 18 that encodes common languages and functions to assist programs that implement the methods of this invention, and software 20 that encodes the methods of the invention in a procedural language or symbolic package. Languages that can be used to program the methods include, without limitation, Visual C/C⁺⁺ from Microsoft. In preferred applications, the methods of the invention are programmed in mathematical software packages that allow symbolic entry of equations and high-level specification of processing, including procedures used in the execution of the programs, thereby freeing a user of the need to program procedurally individual equations or procedures. An exemplary mathematical software package useful for this purpose is Matlab from Mathworks (Natick, Mass.). Using the Matlab software, one can also apply the Parallel Virtual Machine (PVM) module and Message Passing Interface (MPI), which supports processing on multiple processors. This implementation of PVM and MPI with the methods herein is accomplished using methods known in the art. Alternatively, the software or a portion thereof is encoded in dedicated circuitry by methods known in the art.

In one application, the invention features computer implemented modules for studying glycopeptides. Such modules are described here as exemplars of the methods of the invention. Other biomolecules may be studied using similar modules. As described below, the Survey Scan Analysis Module (SSAM) identifies candidate glycoforms in mass spectrometry survey scan data, the Glycopeptide Identification Module (GIM) identifies candidate glycopeptides from MS/MS spectra, and the Glycan Analysis Module comprises a Sugar Structure Identification Module, which can match theoretical sugar structures for an MS-MS spectra to spectra for known sugar structures, and a Protein ID module, which can match the naked peptide of a glycopeptide to its parent protein. The modules of N-GIA, if desired, are run simultaneously in a multiprocessing environment to reduce the time required for analysis. The multiprocessing environment, for example, includes a cluster of systems (e.g., Linux-based PCs) or servers with multiple processors (e.g., from Sun Microsystems), and the methods herein are implemented onto such distributed networks using methods known in the art (see Taylor et al. (1997) Journal of Parallel and Distributed Computing 45: 166-175).

The tool and its modules process and analyze mass spectrometry data. Raw mass spectrometry data files typically consist of MS scans or a series of survey scans and MS/MS cycles for each fraction of a separation. Each mass spectrum corresponds, e.g., to an elution time period for LC or to a fraction for gel electrophoresis, or both. Each survey scan records the number of ions of each m/z value detected by the mass spectrometer. The raw mass spectrometry data files may be generated by various publicly available software packages including, without limitation, MassLynx from Micromass (Beverly, Mass.). To integrate N-GIA with, e.g., MassLynx, software in MassLynx converts the data from the mass spectrometer, for example, into an ASCII or NetCDF format. Other software packages for obtaining mass spectrometry data have similar conversion software. Alternatively, software for data conversion is written using methods known in the art and included in the tool. Optionally, data conversion, may also include merger of multiple files. File merger may also include merger of elements of the files, such as the abundances of particular precursors.

Survey Scan Analysis Module

In a typical proteomic study, all the proteins isolated from the sample are subject to tryptic digestion, and the resultant peptide mixture is separated, often by liquid chromatographic methods (LC) and subsequently analyzed by MS. In the initial round of MS, the masses of each peptidic fragment are recorded in a survey scan. In the survey scan, potential glycopeptides can be recognized by a characteristic distribution of peaks separated by differences equivalent to monosaccharides. After MS, certain fragments can be selected for a second round of MS, in which a fragmentation spectra may be produced through collision induced dissociation which allows for more definitive identification of the precursor. Generally, however, due to their poor ability to ionize, only a small portion of glycopeptides are selected for the second round of MS.

The Survey Scan Analysis Module (SSAM) mines mass spectrometry survey scan data to identify glycoform candidates, which might be glycopeptides, by searching for characteristic glycoform distributions, and allowing selection for further analysis, such as by MS/MS, based on said candidacy. The module comprises a modification of the Peptide Hunter Module (PHM) software included in the Mass Intensity Profiling System patent application (U.S. patent application Ser. No. 10/293,076), which includes the further step of identifying distributions of glycopeptide ion count peaks by monosaccharide differences, thereby determining the presence of glycoforms in the biological sample.

More specifically, the Survey Scan Analysis Module provides a method for determining glycoforms in mass spectrometry survey scan data, said method comprising the steps of: a) providing a biological sample comprising a plurality of biomolecules; b) generating a plurality of ions of said biomolecules; c) performing mass spectrometry measurements on the plurality of ions, thereby obtaining ion count peaks for the biomolecules; d) and, identifying distributions of glycoform ion count peaks by monosaccharide differences, thereby determining the presence of glycoforms in the biological sample. One or more of the identified glycoforms resulting from the use of this method may be selected for MS/MS acquisition.

Determination of a Threshold

Since the SSAM mines the survey scans in the raw mass spectrometry data for evidence of glycoforms, a threshold of ion intensity is defined to differentiate signal from potential glycoforms ions from those of noise. This threshold is estimated for all scans by using methods known in the arts, such methods include, without limitation, the method of Maximum Entropy.

Find Charge States of Precursors in Survey Scans

A survey scan of raw mass spectrometry data is searched for evidence of charged states of precursors. Each charge state consists of a pattern of isotopic peaks. The isotopes of the charged state are separated in a spectrum by 1.0034/z, where z is the charge of the precursor. The “first isotope” of a charge state can be located at a specific m/z value with an isotope located at ((m/z value)+1.0034/z), but without an isotope located at ((m/z value)+1.0034/z) in the spectrum. The second isotope can be located at ((m/z value)+1.0034/z) in the spectrum, and so on.

To identify a charge state for a precursor, a data point corresponding to an m/z can be selected, e.g., on the basis of intensity, from the data in a spectrum. The data can then be searched systematically for neighboring peaks separated by 1.0034/z for a defined number of charges, e.g., +4, +3, +2, and +1. The program searches an appropriate region around 1/z to compensate for uncertainty in the experimental data. The charges can be searched in order from highest to lowest until a peak is found. This order is typically required since, for example, a +4 charged precursor could be mistakenly interpreted as a +1 charged precursor since the +4 charged precursor and the +1 charged precursor both have isotopes at (m/z value of first isotope +1). If no neighboring peaks are found, a charge state cannot be assigned using this method. If a neighboring peak is present, for example, at m/z+0.33, then the charge state can be identified by the separation, which in this case corresponds to the +3 state. Isotopes in a charge state are identified based on one peak and the separation (1.0034/z). Isotopes of a charge state may be assigned to the same mass or m/z, e.g., the mass or m/z of the first isotope, to facilitate integration of peaks originating from the same precursor. The search may require that a peak be a first isotope, and that the second isotope be at least a specified fraction (possibly greater than 1) of the first isotope. Once a charge state is identified, a mass of the precursor may be calculated and used to search for other charge states from the same precursor. By using this procedure, many peaks may be identified from the initial identification of one peak.

In one embodiment, for each peak, m, in the scan, beginning with the most intense peak and progressing to the least intense peak with intensities above the threshold, t, the following steps occur. Alternatively, only a selected number are analyzed as follows. Ion counts within a window, w, around data point m are integrated to obtain abundance, A1. Ion counts within a window, w, around m+0.25 are then integrated to obtain abundance, A2. Ion counts within a window, w, around m−0.25 are then integrated to obtain abundance, A0. If A2 is greater than p×A1 and A1 is greater than q×A0, then m is the first isotope of the +4 charge state of a precursor. Otherwise, repeat the above steps with 0.25 replaced with 0.33, 0.5, and 1 to test for the +3, +2, and +1 charge states. The parameters w, t, p, and q are user defined. The threshold ensures that only peaks of sufficient intensity are examined. The parameters p and q can ensure that a peak is a first isotope by requiring that the second isotope be at least a defined fraction of the first isotope, and that another isotope is not present at ((m/z value)−1/z). Redundancy in the form of multiply identified peptides may be eliminated.

Determine Uncharged Precursor Masses

A precursor can occur in many charge states in the scans of the raw mass spectrometry data, and all or a portion of these charge states may be collected for the precursor. Charged precursor in a scan can be assigned to an uncharged precursor mass using the formula P=(m/z×z)−(1.0078×z), where P is the uncharged mass, m/z is measured by the spectrometer, and z is the charge for electrospray ionization. Other ionization schemes are known in art, and the formula is modified accordingly. Software used in the SSAM may also require that precursors assigned to an uncharged precursor mass have similar retention times. For example, the SSAM would detect a +3 charged precursor with an uncharged mass, P=(658.96×3)−(1.0078×3)=1973.86. This process is sometimes referred to as deconvolution, although that term has other uses in mass spectrometry as well.

Identification of Glycoform Distributions

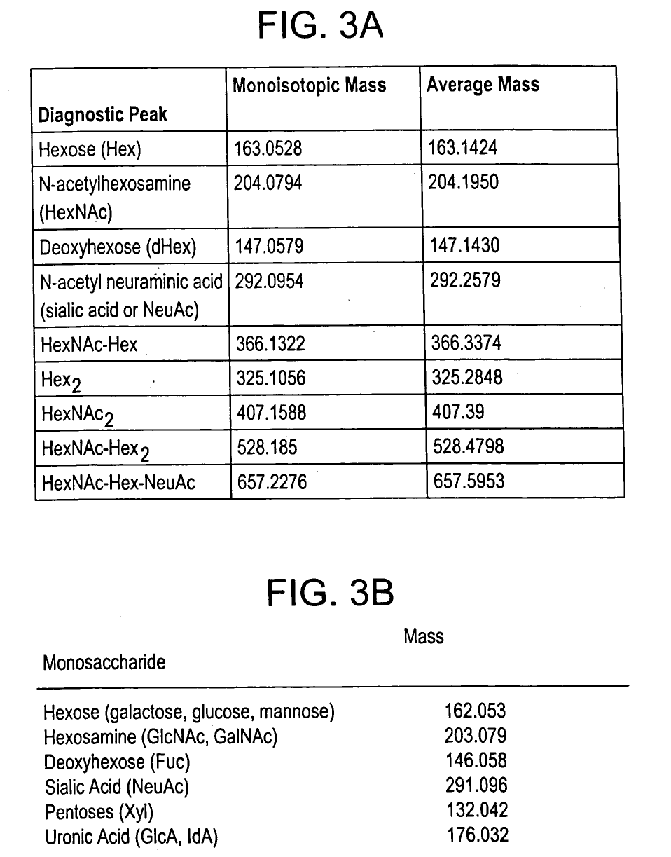

Preferably deconvoluted survey scan data is used to determine glycoform distributions. The stringency of the criteria for judging what constitutes a distribution of glycoform ion count peaks can be varied based on user preference, but minimally a distribution should have at least two peaks separated within a reasonable error by a mass-to-charge ratio that could represent a difference in composition corresponding to the presence or absence of a carbohydrate moiety, to produce a useful basis for limitation of the number peaks selected for further analysis, such as by selection for MS/MS, to fewer than the full range present in the sample. Examples of masses corresponding to monosaccharides are shown in FIG. 3. Precursors identified as potentially differing from each other by m/z differences equivalent to monsaccharide m/zs (determined, for example, from FIG. 3) are determined to be candidate glycoforms.

Individual Glycoform Analyses

The list of candidate glycoform masses and retention times can be used for various analyses, such as MS/MS and subsequent identification of the naked peptide, carbohydrate moiety structure, and candidate parent protein identification. The output of candidate glycoforms need not constitute a list per say, but may comprise, for example, a graphical representation of survey scan data illustrating the candidate peaks.

Glycopeptide Identification Module

This module can be used to mine MS/MS data for glycopeptides. Glycopeptide spectra produced by tandem MS (MS/MS) have several characteristics that enable their being recognized within a group of spectra representing other biomolecules: the presence of oxonium ions, differential peak density, and monosaccharide loss. The inventors have defined a model for glycopeptide spectra based on these attributes. They have also derived a function for evaluating each attribute in a spectrum, with a defined score based on the results of each attribute function, and they have defined a mapping from a score to one of two classes: glycopeptide or non-glycopeptide. The appearance of these glycopeptide characteristics may vary, but as demonstrated with the invention herein, a weighted scoring of their relevance can allow reasonably accurate categorization of spectra by following the steps of the invention. Each spectrum can be scored and classified as corresponding to a glycopeptide or not. The inventors have further incorporated these discoveries into computer procedures and software to allow the automated processing of mass spectrometry data for glycopeptide spectra. The Glycan Analysis Module or other methods may be used on such spectra to further identify and confirm this classification.

These procedures provide a significant time savings, particularly with the quantities of spectra produced in the course of proteomic analysis of a tissue for example. For complex spectra N-GIA may be several orders of magnitude faster than manual examination.

Glycopeptide Fragmentation

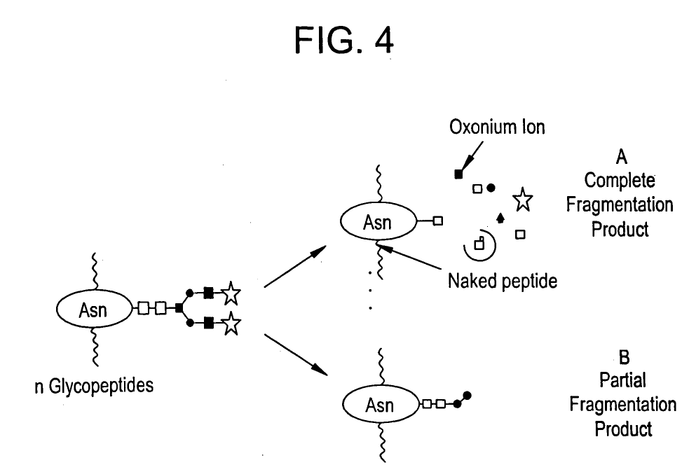

Glycopeptides generally fragment in a predictable and unique way when subject to Collision-Induced Dissociation (CID). The more labile glycosidic bonds of the carbohydrate moiety are broken and the peptide backbone remains unfragmented (FIG. 4). The only monosaccharide of the glycan which does not usually fragment is the first N-acetylglucosamine (GlcNAc) residue linked to the peptide moiety, since the β-glycosylamine linkage of GlcNAc to asparagine (Asn) tends to be stronger than the glycosidic bonds of the rest of the carbohydrate moiety (FIG. 4), however, since several copies of the same glycopeptide enter the MS/MS chamber simultaneously, depending on the ionization energy used, after CID there should exist several species with the carbohydrate moiety fragmented to varying degrees which could be detected by the mass spectrometer. FIG. 4 illustrates the process of glycosidic bond breakage and complete and partial glycopeptide fragmentation. The breakage of the glycosidic bonds, thus can yield two predictable categories of fragmentation products that can appear in the MS/MS spectrum: low mass oxonium ions produced when dissociated monosaccharide residues obtain a positive charge and thus are registered by the mass spectrometer, and ions corresponding to the peptide moiety coupled with a partial carbohydrate moiety that remains covalently bound after fragmentation. Fragmentation products are registered by the mass spectrometer and a spectrum is produced illustrating the relative amount of each species at their corresponding particular m/z value.

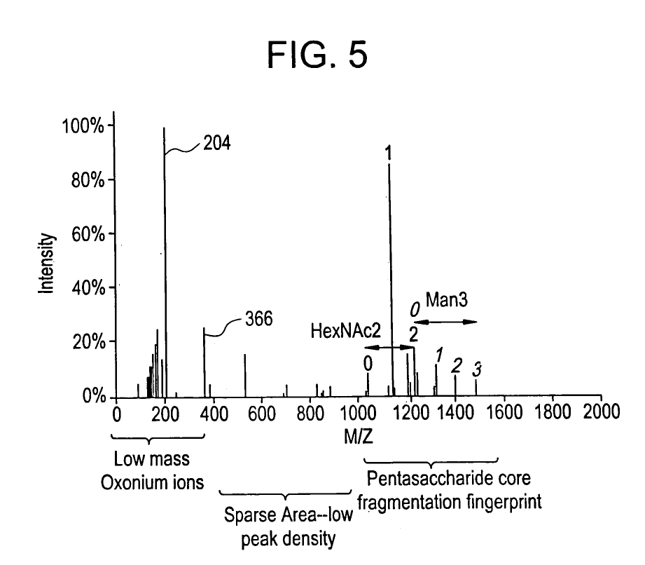

The appearance of oxonium ions in the low-m/z range of the spectrum (FIG. 5) can be a key element in the identification of a glycopeptide. Commonly seen oxonium ions in glycopeptide spectra are listed in FIG. 3. As reported by Carr et al. (Protein Science (1993) 2: 183-96), the observation of some oxonium ions is more common than others. Almost all glycopeptide spectra contain the N-acetylhexosamine (HexNAc+) ion (m/z 204) and many also contain HexNAcHex+ ion (m/z 366). It is also common to observe a ladder of oxonium ions in the low m/z range of the spectrum, for example, oxonium ions at m/z 204 (HexNAc) and m/z 366 (HexNAcHex), as well as m/z 528, which represents an ion corresponding to a partially fragmented structure that could further fragment into the m/z 204 and 366 ions.

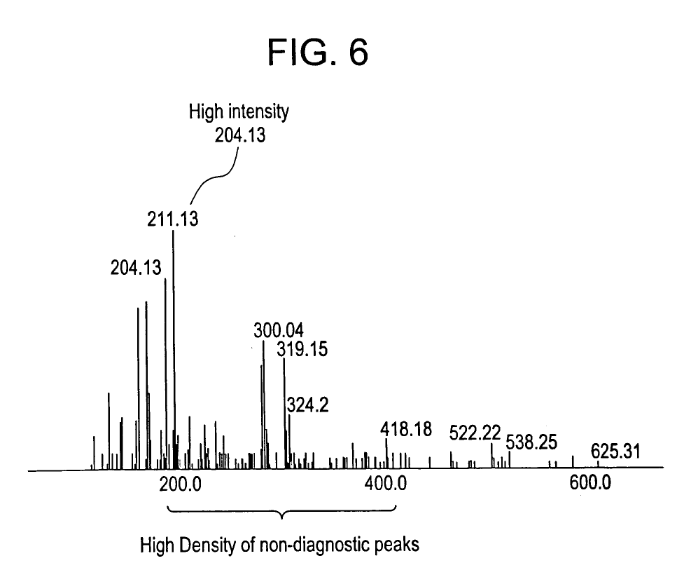

Oxonium ion presence could be used by itself to identify a set of spectra, however in a mixed sample of various types of biomolecules, such as may often be present in a biological sample, oxonium ion presence alone is not likely to be an accurate diagnostic for glycopeptides, identifying, for example, spectra containing carbohydrate moieties, but lacking a peptide moiety. In FIG. 6, the spectrum could give a potential false positive if oxonium ion presence was the sole criteria for determining glycopeptide spectra, as, without further indication that the spectrum represents a glycopeptide, the peaks from the GK di-peptide might be interpreted as possible oxonium ions.

In addition to oxonium ions, partially fragmented glycopeptides resulting from glycosidic bond breakage could be recorded in the high m/z range of the spectrum. Each representative peak is generally separated by some combination of saccharide masses (see FIG. 5), and may represent a ladder of monosaccharide losses from the carbohydrate moiety (hence the characteristic in general can be referred to as “monosaccharide loss”). Like oxonium ion presence, monosaccharide loss could possibly be used as a single criterium for determining whether a spectrum was generated from a glycopeptide or not, or even used with a second characteristic, but with possibly less accurate results than with the primary embodiment of the invention as presented herein.

Unlike peptide spectra, the distribution of peaks in glycopeptide spectra is non-uniform, and this characteristic is referred to herein as “differential peak density”, or as the spectrum having an area of low peak density. Since the peptide backbone does not fragment, the oxonium ions and the partial glycopeptide fragments are separated by a mass equivalent to the unfragmented backbone. In the high m/z range, this generally results in a high peak density as there are generally peaks representing each partial carbohydrate moiety attached to the peptide moiety that has an unique mass. In the m/z range lower than the unfragmented backbone but greater than the common range of the oxonium ions, generally the mid-range of the spectrum, there tend to be very few peaks (peaks in this area usually consist of +2, +3 charged peaks corresponding to +1 peaks of the upper m/z range). In the low m/z range, the peaks are generally quite sparse as well, with the exception of the oxonium ions peaks. This pattern of differential peak density is also a distinguishing feature of glycopeptide spectra, that might be used alone to analyze spectra as corresponding to a glycopeptide or not, though the results would be of questionable accuracy, as compared to an analysis combining differential peak density with one or more additional appropriate characteristics, such as in the primary embodiment described herein.

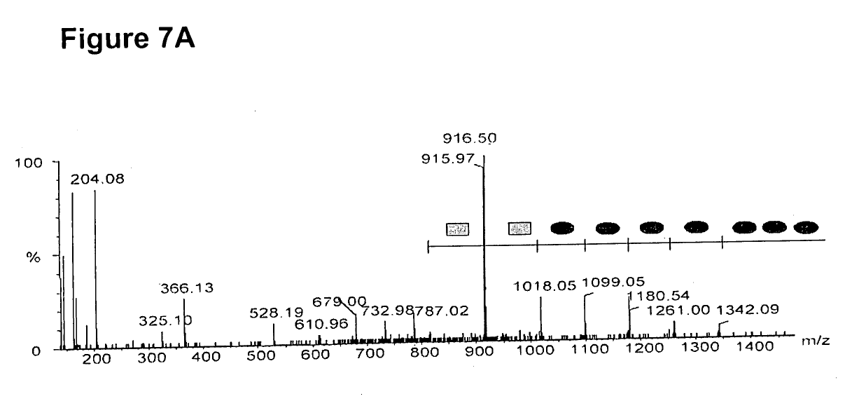

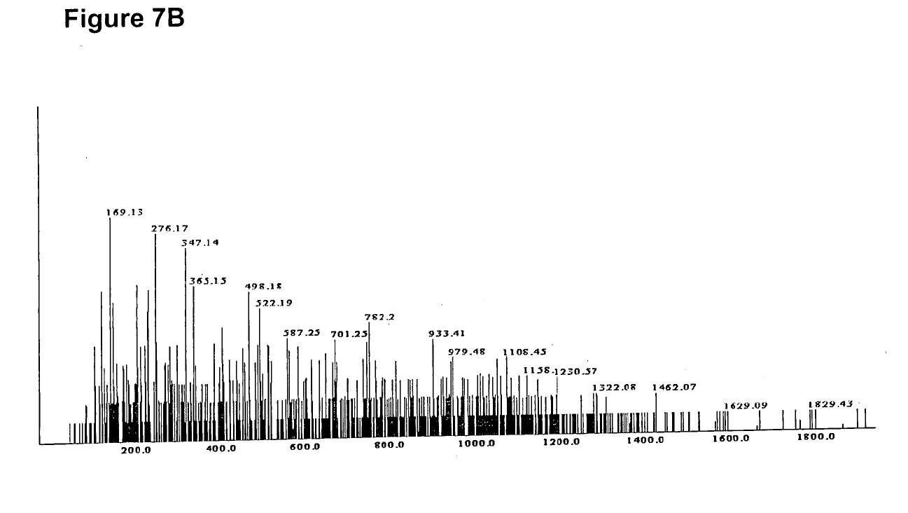

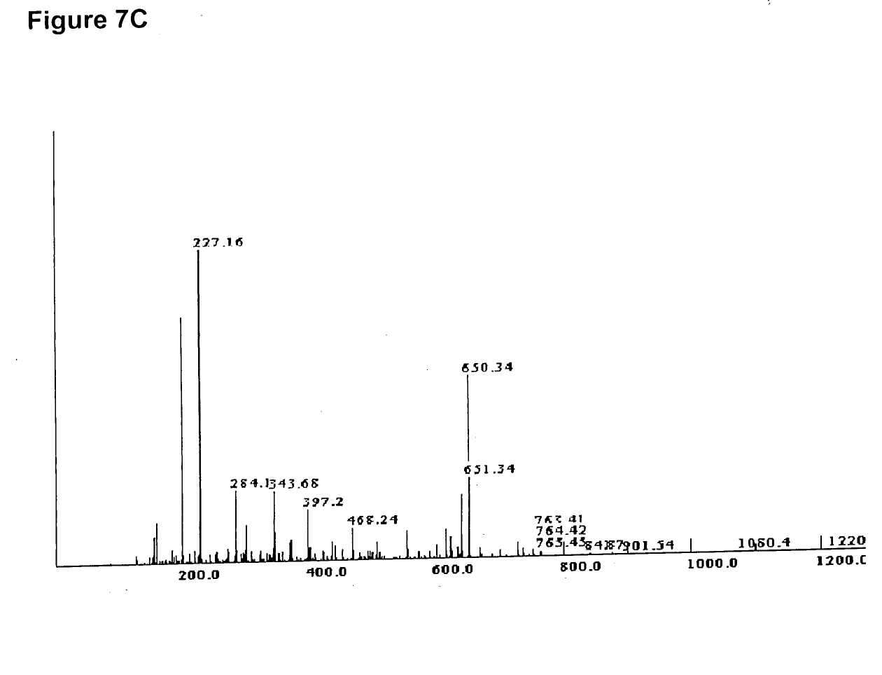

These characteristics of the fragmentation patterns of glycopeptides—low m/z oxonium ion peaks, high m/z peaks spaced by various saccharide combinations (the glycopeptide fragments containing the peptide), and differential peak density—creates spectra which are often identifiable by visual inspection. A typical glycopeptide spectrum is illustrated in FIG. 5. And, in FIG. 7, the general appearance of glycopeptide spectra is contrasted with those of non-glycopeptide spectra (FIG. 7b) and peptide spectra (FIG. 7c). However, not all glycopeptide spectra are visually so straightforward that they do not require time consuming and labor intensive analysis. As noted, there are possible confounding factors affecting the accuracy of the individual characteristics. Some additional factors include spectrum quality, since glycan structure can affect the number and intensities of the peaks present; and altered fragmentation patterns, since some monosaccharides, such as sialic acid, can affect the fragmentation of the glycopeptide. And, the structure of the glycan and the energetics of the structure can also bias the fragmentation. All of these effects and others could hinder simple visual inspection and lower its accuracy as compared to the systematic approach of the invention, particularly its computer procedural form. Embodiments of the invention utilizing multiple characteristics to assess the spectra in particular should be flexible enough to overcome many, if not all, of these confounding factors.

The potentially voluminous amounts of data produced in sample analysis by mass spectrometry, particularly when running in a high-throughput manner, are also unlikely to be analyzed by simple visual inspection in an accurate, timely, and cost-effective way. The inventors have developed computer procedures that permit accurate automated determination of glycopeptide spectra based on their fragmentation characteristics. These procedures may be used with individual spectra, or with groups of spectra, including those produced through the high-throughput mass spectrometric analysis of biological samples.

The procedures for glycopeptide spectra determination can be used as a general method for manual or automated analysis of MS/MS spectra. Thus, in one embodiment of the invention, the invention provides a method for determining glycopeptides in mass spectrometry MS/MS data, said method comprising the steps of: a) providing a biological sample comprising a plurality of biomolecules; b) generating a plurality of ions of said biomolecules; c) performing mass spectrometry measurements on the plurality of ions, thereby obtaining MS/MS spectra for one or more biomolecules; d) assessing one or more MS/MS spectra for the presence of oxonium ions, a low peak density area, and monosaccharide loss; e) scoring the spectra; f) comparing the spectra scores to a glycosylation threshold, g) classifying spectra as glycopeptide spectra or not based on the results of the comparison of spectra scores to a glycosylation threshold.

The procedures and materials of steps a)-c) are as described previously. In steps d)-g) data from one or more MS/MS spectra is assessed as discussed below. A scoring format and glycosylation threshold is also discussed as an exemplar based on the inventors' experiments. Those skilled in the art should find it easy to adopt the scoring and threshold as well as adapt the scoring and threshold to new datasets and in further refinements utilizing one or more of the key criteria set out herein (presence of oxonium ions, low peak density area, and monosaccharide loss).

Assessing for Oxonium Ion Presence

Oxonium ion presence can be assessed by scoring one or more oxonium ion characteristics, with the score providing a relative, though not necessarily linear, weighting to the spectral evidence of oxonium ions. Such characteristics include, but are not limited to, significant peaks at predictable oxonium ion m/z values, oxonium ion ladders, and peak density. Optimally, a scoring method for evaluating the presence of oxonium ions in an MS/MS spectrum would return a value based both on the appearance of peaks at the m/z values of oxonium ions and confidence level that they are not random peaks, such as can be provided by the presence of oxonium ion ladders.

Oxonium Ion Peaks

A spectrum can be searched for significant potential oxonium ion peaks and their intensities noted. One of most important criteria in confirming the validity of a peak in an MS/MS spectrum, is the assessment of the peak being significant. The main criteria used in classifying a peak as significant is its intensity measure. Peak intensities depend strongly on the physical and chemical properties of the glycopeptides, so it is often incorrect to assume that the more intense peaks are more valid than the weaker ones. In carbohydrate spectra, peaks with low intensity often represent valid fragment structures, but which, due to the chemical property of the glycan, are less likely to fragment.

Since ESI-MS/MS spectra exhibit a great deal of random noise, during the processing of the data, the mass spectrometer determines the background noise level and normalizes all peaks of the spectrum according to this value. A common metric used to distinguish a valid peak from background noise is that the peak should be at least 3 times as intense as the background noise level. This requirement examines the intensity of a peak relative to the entire spectrum, and rules out peaks which can be attributed to electrical noise, which in some spectra can appear at almost every m/z unit.

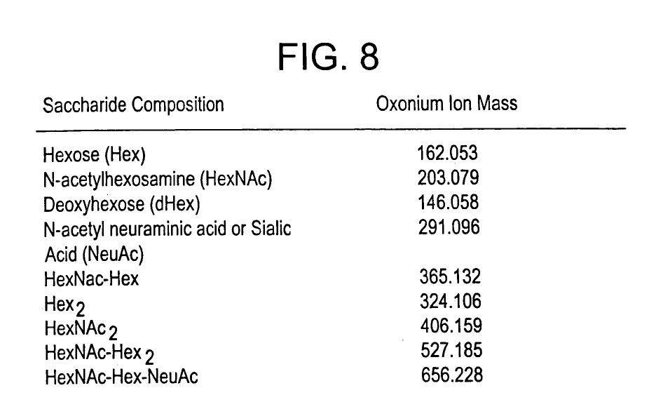

Commonly seen oxonium ions are listed in FIG. 8. The search for oxonium ions need not be exhaustive, but preferably reflects those oxonium ions likely to be exhibited in glycopeptide spectra from the sample being evaluated.

Oxonium Ion Ladders

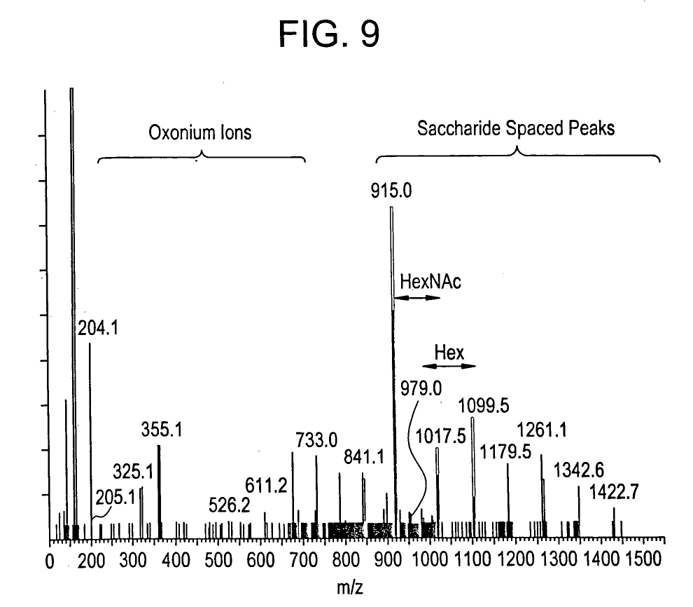

Although the presence of multiple oxonium ions found in the spectrum can be taken into account, the additional confidence that logical patterns within the oxonium ion peaks themselves provides is also reasonable to score, as they can be seen as lowering the likelihood that the individual peaks are random events. For example, oxonium ions can form a “ladder of peaks”, if the glycopeptide contains a HexNAc₂-Hex in its carbohydrate moeity, such as if significant oxonium ions of 204 (HexNAc) and 366 (HexNAc-Hex) are both observed in addition to a peak at m/z 528 representing HexNAc₂-Hex (FIG. 9). The presence of all 3 peaks simultaneously increases the probability that the peaks individually represent valid oxonium ions. Ladders of oxonium peaks tend to be found in glycopeptides with larger carbohydrate moieties however, and many glycopeptides have only 1 or two oxonium ions, usually at m/z 204 and 366, so while providing more confidence, ladders should preferably not be relied on to the exclusion of individual oxonium ion presence except in rare circumstances where the sample comprises primarily glycopeptides with larger carbohydrate moieties or only the glycopeptides with oxonium ion ladders are of interest.

Peak Density

In ideal glycopeptide spectra, fragments found in the low m/z range should consist of only oxonium ions peaks (FIG. 5) since the peptide backbone does not generally fragment. As such, the ratio of diagnostic peaks to non-diagnostic peaks in this m/z range should be fairly high. The density of peaks which do not represent oxonium ions is an additional metric which can assess the validity of the entire set of oxonium ions observed in the spectrum. In the example illustrated in FIG. 6, the density of peaks surrounding the peak at m/z 204.13, the same m/z as that of a HexNAc oxonium ion, suggests that the spectrum does not represent a glycopeptide. Furthermore, if the set of all oxonium ion peaks are among the most intense peaks in the low m/z range, there is additional confidence that the peaks are valid.

Function for Oxonium Ions Evaluation

In one embodiment the invention provides for oxonium ion presence to be assessed by summing scores representing oxonium ion presence, oxonium ion ladder presence, and peak density found in a spectrum, as well as a score evaluating of the set of all oxonium ion peaks found in the spectrum. This provides a combined score for use as a relative measure of oxonium ion presence.

The inventors have found it best to weight these components (oxonium ion presence, oxonium ion ladder presence, and peak density). A constant factor a is applied from evaluating the prevalence of the oxonium ion in glycopeptide spectra. This factor weights based on the probability of observing a specific oxonium ion. Such probabilities can easily be determined by one skilled in the art for an appropriate sample type, for example colon cancer tumor tissue. α are assigned for each type of oxonium ion for which a spectrum will be evaluated.

A constant factor of β is used to weight the presence of an oxonium ion ladder. For an oxonium ion representing a di- or tri-saccharide observed along with oxonium ions that represent its component monosaccharides, a constant factor of β is also added to the score. Again, such weights are probablistically based and can readily be posited by one skilled in the art.

To incorporate information about the entire set of oxonium ions found, a metric δ can derived to evaluate the ratio of non-oxonium ion peaks to oxonium ion peaks in the low m/z range. This score is subtracted from the other components of the score to penalize very dense spectra which randomly contain peaks at oxonium ion m/z values. Additional characteristics might also be assessed, including, but not limited to, factors such as water loss of the oxonium ions, which can result in the appearance of high intensity peaks at m/z values 18 mass units lower than the oxonium ion peaks of corresponding charge. Such factors can be used, for example, to correct the count of non-oxonium ion peaks and report a higher tally of oxonium ions.

Overall, the function for oxonium ion evaluation can be defined as follows:

f_{OxoniumIons}=Σⱼ₌₁^{j=m}((αⱼ+βⱼ)*Intensity(j))−δ

where m is the total number of significant oxonium ions detected in the input spectrum as determined above. The resulting score can be taken as a measure of oxonium ion presence.

Assessing for a Low Peak Density Area

Observation of a pattern of differential peak density in the spectrum is also a criteria for determining if a spectrum corresponds to that of a glycopeptide or not. The high m/z range peak density is generally not considered as the inventors have found that glycopeptide spectra obtained by MS-MS are frequently of low quality and often do not contain many peaks.

To derive a measure of the sparsity of the m/z mid-range zone (preferably m/z 366 to m/z 666), a tally of the significant peaks which do not represent known oxonium ions is taken. The number is then discretized to a score out of 40 to represent 3 qualitative classifications of peak densities: sparse, not sparse, and dense.

Assessing for Monosaccharide Loss

Many glycopeptide spectra can be accurately identified by the presence of oxonium ions and differential peak density alone, but the presence of an additional characteristic—peaks separated by an m/z corresponding to monosaccharides (see FIG. 3) or combinations thereof, referred to herein as “monosaccharide loss”—can be included in the determination to increase accuracy. Indeed, the formula provided in this embodiment does so, though monosaccharide loss is given much less weight than the other two characteristics. The m/z of peaks above background in the high m/z range are separated by m/z values corresponding to m/z values seen in monosacchraride loss within a error. The number of peaks separated by an m/z of 204 (N-acetylhexosamine (HexNAc)) or 162 (Hexose (Hex)) were counted for peaks in the high m/z range to give a score. It is quite common to observe peaks separated by monosaccharide masses randomly in non-glycopeptide spectra and as such, this metric is not discriminating enough for glycopeptide detection on its own.

Scoring the Spectrum

Scores having been determined for the presence of oxonium ions, monosaccharide loss and an area of low peak density in a spectrum or spectrums, an overall score can be determined to evaluate a spectrum as corresponding to a glycopeptide or a non-glycopeptide. While it is common to observe each of the glycopeptide features assessed by the invention individually in non-glycopeptide spectra, the combination of each of these features, and their weighting, is desirable for effective spectrum classification. The individual characteristics, or pairs thereof, could be used—effectively giving zero weight to the other(s)—but preferably the three characteristics are used. One skilled in the art can easily adjust the weighting scheme, but for an exemplary embodiment the following weights were assigned to each feature:

50%—Oxonium Ion Presence. The presence of peaks located at known oxonium ion m/z values tends to be the most informative feature in glycopeptide detection. Oxonium ion masses however are not completely unique (Oxonium ions have unique masses when given a high enough precision. For example (see FIG. 6), a HexNAc oxonium ion has a precise mass of 204.09 whereas a peptidic y2-GK fragment has mass 204.13. However there is a limitation on the precision of the mass spectrometer and at the level of accuracy used, it may not be accurate to use precise values for searching oxonium ions). Thus, the presence of oxonium ions alone is not always sufficient for the identification of glycopeptides, and weighting should take this into consideration.

40%—Assessment of Low Peak Density Area. Although peptidic spectra contain mainly uniformly distributed peaks, it is remains possible that peak densities could vary in the spectrum, and thus, like oxonium ion presence, this criteria is not always sufficient alone.

10%—Monosaccharide Loss. It is highly likely that peaks appearing in MS/MS spectra are separated by mass differences equal to various combinations of saccharides spuriously. This greater potential for false positives accounts largely for the lesser weighting.

A total score S for glycopeptide classification can thus be described as:

S=(f_{OxoniumIons}*0.5)+(f_{peakdensity}*0.4)+(f_{monosaccharide loss}*0.1)

Standard mass spectrometers produce output as a vector of pairs of real numbers (m/z, intensity). Each function f therefore takes in as input vector E which represents all (m/z, intensity) pairs of the experimental spectrum. Each fi for attribute Xi was derived such that, based on the weights assigned to each feature as described in the previous section, wi, the sum of each wifi for an idealized glycopeptide spectrum would produce a score of 1. Given the variations of glycopeptide spectra discussed, each fi developed should be sensitive enough to assign a correct score to noisy glycopeptide spectra while being discriminating enough to eliminate false positives. The resulting score, S, can be compared to a glycosylation threshold to determine whether a spectrum corresponds to a glycopeptide or not.

Glycopeptide Score Threshold Establishment

The glycopeptide score described in the previous section reflects the similarity of the spectrum to an idealized glycopeptide spectrum. Given the variation observed in glycopeptide spectra, many glycopeptide spectra will appear dissimilar and there will be a range of scores produced. To classify a spectrum as belong to a glycopeptide requires the establishment of a decision score D (the glycopeptide threshold) such that:

if S<D, the spectrum is not a glycopeptide, and

if S>D the spectrum is a glycopeptide.

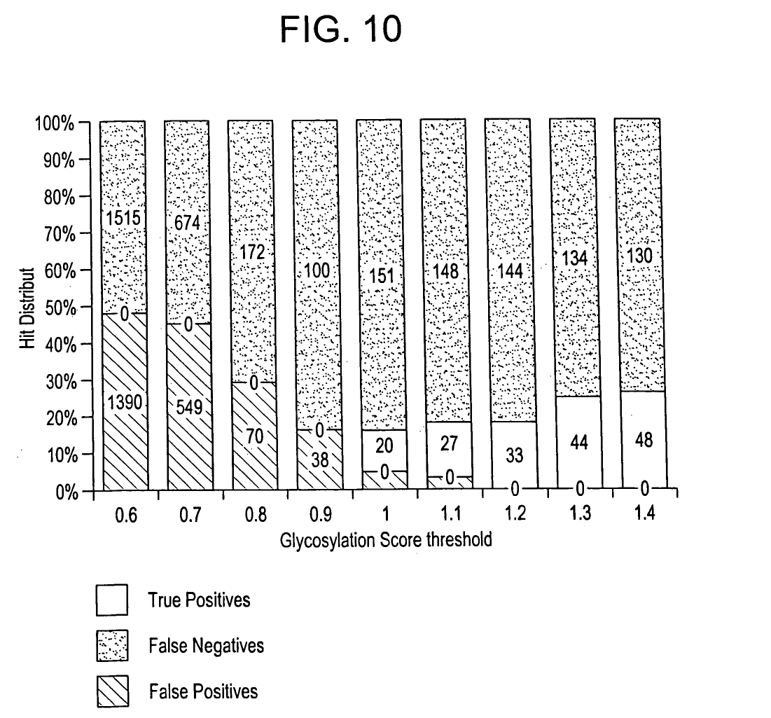

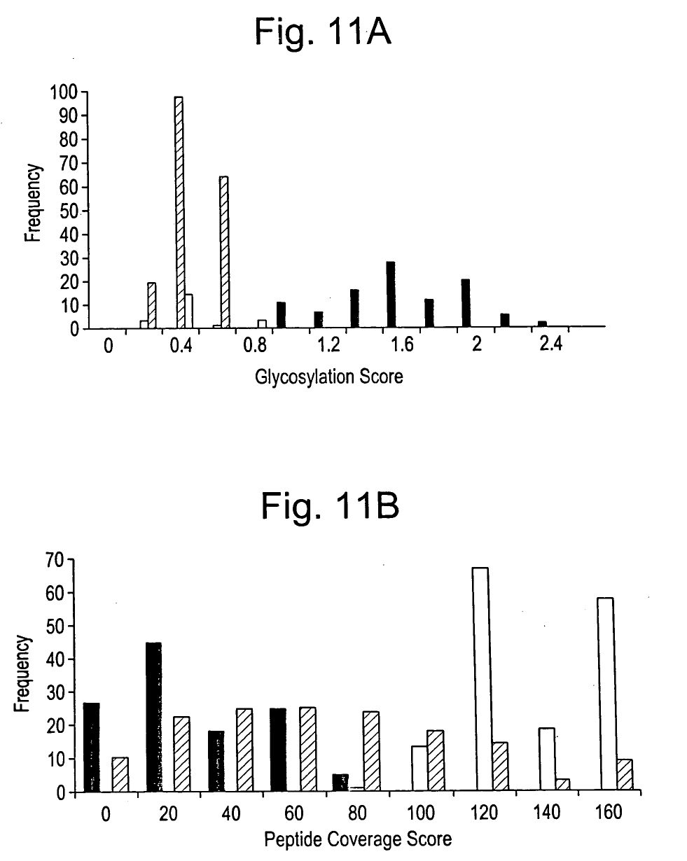

A decision score is established for an embodiment of the invention by considering the score which will return the optimal ratio of false negatives to false positives (see FIG. 10 and FIG. 11). It should be recognized that several methodologies exist in the art for determining an accurate decision boundary, and that the choice of a method is not central to the invention, nor are the exact boundaries.

It should be noted that although the parameters used herein for the identification of characteristics, scoring, and mapping with regard to glycopeptide spectra have been shown to be useful, variations on and alterations in the weighting scheme may be made. Such alterations may be arbitrary or empirically determined. In particular such changes might be made to adjust the accuracy. For example, a significant change in sample composition might require adjustment of scoring parameters to eliminate an increased percentage of false positives compared to that exemplified here, or looser parameters may be desired to prevent false negatives. Similarly, adjustments may be made to parameters to optimize the speed of the process.

Glycan Analysis Module

In addition to oxonium ions, the partially fragmented glycopeptides resulting from glycosidic bond breakage are also recorded in the high m/z range of the spectrum. Each representative peak is separated by some combination of saccharide masses (see FIG. 5). By observing the differences between these peaks in the high m/z range and finding the peak corresponding to the naked peptide, the structure of the glycan can be reconstructed. Identification of the naked peptide also provides a way to identify the parent protein for the glycopeptide, which can further allow comparison of the glycosylated and non-glycosylated forms of the peptide.

Sugar Structure Identification Module

Manual reconstruction of glycan structures from MS/MS spectra involves detecting mass differences between the high intensity peaks of the spectrum. The order in which the mass differences are observed between the various peaks suggests the order of monosaccharide dissociation and thus the composition of the glycan. Multiple monosaccharide differences originating from the same peak and the relative intensities of the peaks observed also suggests the branching points in the glycan. With the incorporation of known rules about glycan structure and biosynthesis, the branch points and the monosaccharide composition, the glycan structure can be elucidated. Obfuscating factors such as missing or additional peaks and multiply charged peaks in ESI-MS/MS however, can complicate the task of glycan structure significantly.

To automate the process of glycan structure elucidation from ESI-MS/MS data, the invention presents an approach based on the adaptation of traditional techniques of MS/MS ion searching for glycan analysis. Most MS/MS ion searching techniques thus far have catered to peptide fragmentation and are not applicable to glycopeptide analysis. For application to glycan analysis, existing peptide MS/MS ion searching techniques were modified in two main respects: the branched structure of carbohydrates requires a unique model for theoretical fragmentation, and the unique features of glycopeptide spectra require that methods of spectra correlation also be changed.

As in peptide MS/MS ion searching, the glycan ion MS/MS ion searching aspect of the module involves three main steps:

1. Obtaining a suitable database of structures which could correlate to the experimental spectra.

2. Generating theoretical spectra representing predicted fragmentation products of database entries.

3. Correlation of the theoretical spectra to the experimental spectra and determination of a most likely match.

Each of these steps will be further discussed in the following sections.

Glycan Database

A database of glycan spectra can be produced from known glycans by subjecting individual glycans to MS/MS analysis and preserving the spectrum and the glycan they correspond to. Commercial databases of glycan structures, such as GlycoSuite DB (Proteome Systems Limited) are also available. The embodiment discussed below focuses on N-linked glycans, however, one skilled in the art should be easily able to adapt this module to O-linked glycans.

The database is not likely to provide a complete set of all N-glycans found in Nature and it is possible that not all experimental glycan spectra match exactly with database glycans. The reliance of MS/MS ion searching techniques on the completeness of the database used is an inherent limitation of the technique. However, a secondary goal of MS/MS ion searching techniques is to return the most similar or homologous structure in case the experimental structure is not reported in the database. Since N-linked glycans have a well-defined structure and are generated by similar biosynthetic mechanisms, it is likely that the database will contain a very similar sugar in case the exact structure is not contained in the database.

Generation of Glycan Carbohydrate Theoretical Fragmentation Spectra

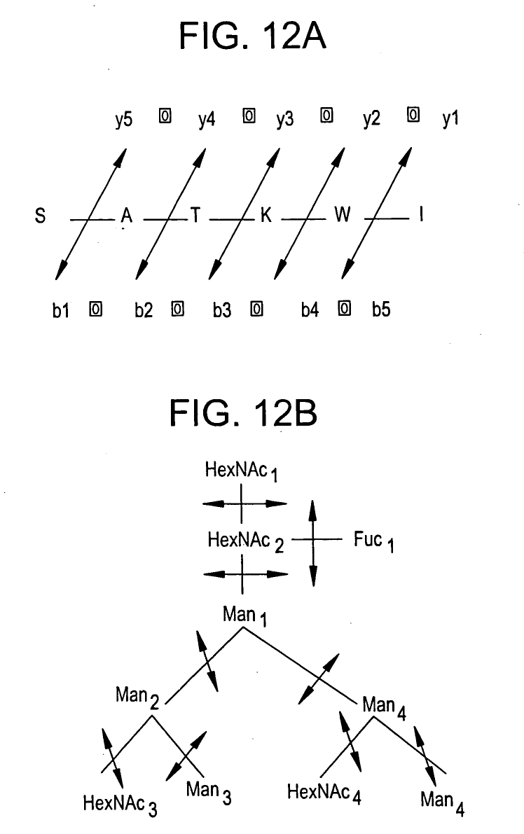

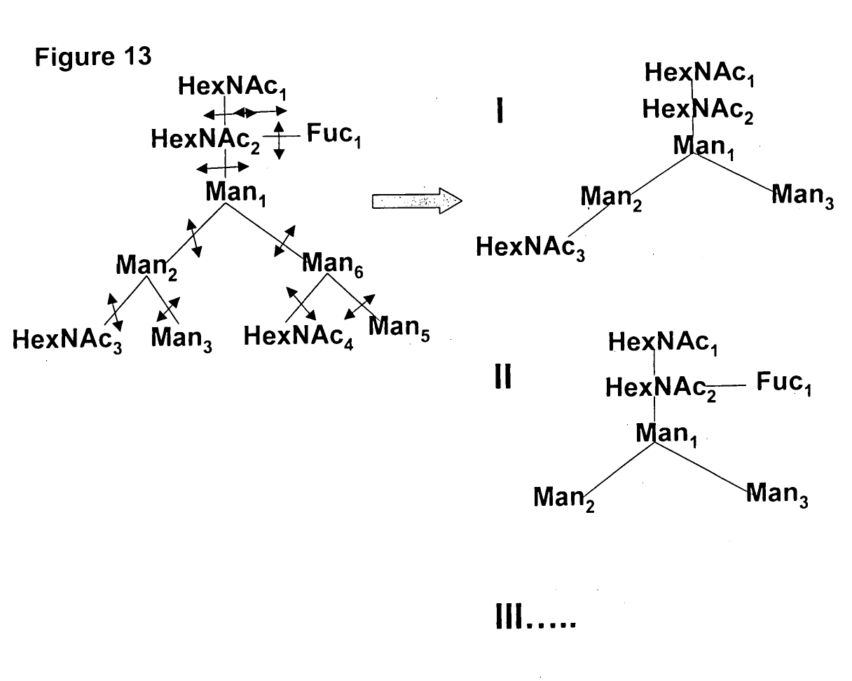

Unlike known peptide fragmentation models, carbohydrate fragmentation is quite complex due to the presence of branches (FIG. 12). Theoretical peptide fragments are created by breaking each of the peptide bonds, and adding the masses of the amino acids of the resulting fragments in strictly linear combinations. The number of partial fragments created will in theory equal the number of peptide bonds present (considering either the b-, or y- ion series). Since glycans are branched structures and there can be simultaneous fragmentation events along each branch, the set of peaks produced will include some peaks representing combinations of masses between partially fragmented branches (see FIG. 13).

The number of fragments observed is carbohydrate spectra however, is much smaller than the set of all predicted fragments. For one, not all fragment species may arise with the same probability. The structure and composition of each carbohydrate produces an overall chemical energy of the molecule which in turn introduces a bias for the observation of some fragmentation products more than others. The chemical properties of individual monosaccharides can also produce a fragmentation bias. The positive charges present on sialic acid residues for example cause them to dissociate more readily than other monosaccharides. Another factor influencing the number of glycan fragments observed is the energy of dissociation used for the fragmentation. High energy collisions will break more glycosidic bonds in the structure and as such contribute to the observation of more fragment species and more peaks in the spectrum.

Another major reason that the number of observed peaks is generally much smaller than all possible peaks is that many fragmentation products have the same composition. The set of all possible peaks in the spectrum are also reduced since carbohydrates in higher animals and humans are generally composed of a maximum of 6 monosaccharides of which 2 are rare (FIG. 3b). As such, for any glycan it is likely that various fragment species originating from different parts of the structure contain the same monosaccharide composition and thus produce fragments with the same masses.

N-linked carbohydrate structures found in nature all contain the pentasaccharide core HexNAc₂Man₃ from which stems 2 antennae, or branches. There are several tri-antennary structures although they are not as common as bi-antennary structures (There are also some N-linked glycans with a single GlcNAc residue, called a bisecting GlcNAc, attached to the core in addition to the two antenna. These structures are also not as common as bi-antennary N-linked glycans.). Based on this structure, carbohydrates assume rooted, binary tree structures with nodes representing the monosaccharide residues, edges representing glycosidic bonds and a root representing the initial HexNAc₂Man portion of the N-linked core (see structures illustrated in FIG. 13 for example).

The set of peaks created by a “full” model of carbohydrate fragmentation that considers all possible theoretical fragmentation products can become very large depending on the structure of the glycan. Consequently, there is an increased likelihood of obtaining non-specific hits in many cases. Although this would be a possible embodiment for a Sugar Structure Identification Module, a preferred embodiment follows a “path model”, an alternate fragmentation model which produces a set of peaks S, which is a subset of F (that produced by a full model), but which will be still be complete enough to correlate database glycan structures to experimental glycan spectra, as exemplified herein.

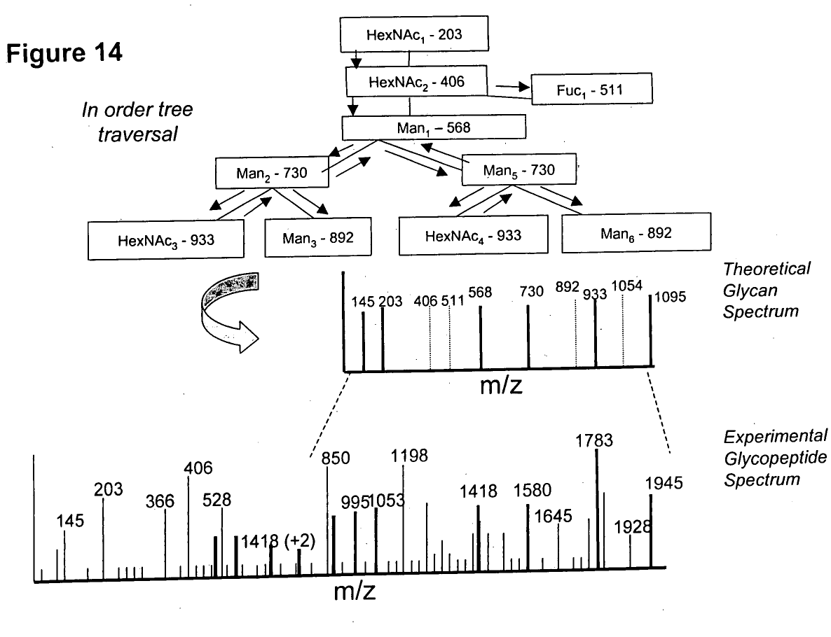

In a study put forth by Mizuno et al. ((1999) Analytical Chemistry 71: 4764), it was found that ions produced by a single-bond cleavage were more abundant than fragment ions resulting from multiple-bond cleavages, and that fragmentation initiated in a branch proceeds to the end of the same branch. Based on this result, the Path Model of glycan fragmentation was developed. To produce a subset S of all possible fragmentation products F, the path model performs an in-order tree traversal of the carbohydrate structure. The root node is assigned the mass of a candidate naked peptide peak (see below) and all other nodes assigned the mass of the glycopeptide product that would result from fragmentation at that point. A theoretical spectrum for the glycan is obtained by performing an in-order tree traversal of all paths from the root to each of leaves and retaining the masses at all nodes traversed in the path. Redundant product masses are counted only once to produce a set of unique peaks representing various fragmentation products of the glycan. Only products resulting from paths from the root to each leaf are considered i.e. subtree mass combinations were not examined for simplicity. The peaks generated by this model are then subsequently to be correlated to the experimental spectrum. This process is illustrated in FIG. 14.

Algorithm for Spectra Correlation

After the creation of the theoretical spectrum modeling carbohydrate fragmentation, the theoretical spectrum is correlated with the experimental spectrum. This correlation differs from existing methods for peptides in 2 main ways:

Unknown point of attachment of the glycan to the peptide backbone: Since the peptide moiety of glycopeptides remains intact after fragmentation, the peak representing the starting point of the glycan is not immediately known. When analyzed, this peak, the naked peptide is determined by tracing monosaccharide loss sequentially and finding the most likely point of attachment.

Detecting branching patterns in the spectra: Due to the possibility of mass combinations formed between branches, there is more ambiguity in the assignment of glycan structures to experimental spectra as discussed in the previous section. This factor should be taken into account when deriving an appropriate scoring scheme to evaluate the degree of matching between the theoretical and experimental spectra.

Exemplary approaches used in the correlation of the theoretical spectra generated by the Path Model and the experimental spectra of glycopeptides are discussed below.

Naked Peptide Determination

In order to match the theoretical glycan peaks of the experimental spectrum, the offset of the peak representing the peptide moiety should be determined, the ‘naked peptide’ in the experimental spectrum. Since the naked peptide peak of the glycopeptide is not always easily identifiable, it is necessary to determine this point before the correlation of the spectra can begin. Determination of this peak also allows analysis to proceed to the Protein ID module, and the procedures for its determination may likewise be embodied within a Protein ID module or as a part of the overall Glycan Analysis Module that feeds into either or both of the two sub-modules (Sugar Structure Identification and Protein ID). In general, the Glycan Analysis Module provides a method for determining the most likely naked peptide for a glycopeptide spectrum from a group of candidate naked peptides, comprising: providing a group of candidate naked peptides for a glycopeptide spectrum; applying theoretical sugar fragments to the candidate naked peptides; determining correlation scores for the resultant candidate glycopeptides; and determining the highest scoring match from the group of candidate glycopeptides, from which the carbohydrate portion indicates the optimal sugar structure, and the peptidic portion indicates the most likely naked peptide.

In N-linked glycopeptides, the naked peptide peak is traditionally amongst the most intense peaks of the spectrum (though not always). A simple approach to determining the naked peptide is the generate a list of the most intense peaks in the high m/z range of the spectrum to provide a group of candidate naked peptides, and try each one (Since the naked peptide could be a +2 or +3 charged peak, all of the charge states of the naked peptide are also tried as potential starting points) as a potential starting point by applying theoretical sugar fragments. In theory, when the correct database glycan is applied on the spectrum at the correct point, there should a maximal number of matching peaks and thus the highest correlation score returned. The top candidate matches (see below) therefore, should provide the optimal sugar structure matching the peaks as well as the most likely naked peptide.

Correlation of Theoretical and Experimental Spectra

From each naked peptide candidate, the peaks of the theoretical spectra are matched to those in the experimental spectrum. To evaluate the degree of matching, an appropriate correlation scoring scheme must be developed. As with the scoring schemes used in peptide MS/MS ion searching, the intensities and number of matched peaks is incorporated in the scoring scheme. In addition to these common features, it is useful to incorporate some information on the structure of the glycan.

In the embodiment exemplified herein, glycan substructures are examined to this end. The structure of each branch of the glycan is verified. The theoretical fragments created along each branch of the candidate glycan are checked in the experimental spectrum and a score assigned to the appearance of contiguous peaks along this branch. The more contiguous peaks along a substructure that are observed, the greater likelihood of that substructure being correct. For each contiguous peak observed, a constant factor of β, which can be chosen to reflect the quality of the spectrum (i.e. the presence of a complete ladder of fragment ions), is added.

Branch Score

Each branch of the glycan structure is scored separately in order to verify the glycan substructure. The score for each branch consists of the sum of all the intensities of the matched peaks and a score based on the branch structure.

When searching a theoretical peak in the experimental spectrum, the peak mass is searched in several charge states as peaks in ESI-MS/MS spectra exist in +1, +2 and +3 charges. The intensities of all peaks in the spectrum which lie in a window of 1 dalton around the theoretical peak and are found to be significant, are summed and added to the final score.

As described in the previous section, a score for the number of contiguous peaks along any one branch which are observed is determined by qβ where q is the number of contiguous peaks observed and β is a constant factor.

The branch score also includes the ratio of the number of matched peaks to the number of peaks expected by the fragmentation of the branch. This way, branches which contain a common starting point but which are much longer are eliminated as potential hits.

In formal terms, the branch score can be described as follows:

B=(Σᵢ₌₀^{i=m}intensity(i))+qβ+(m peaks/number of expected peaks)

where m is the number of matched peaks and q is the number of contiguous peaks found.

The overall score for the match of the entire theoretical glycan to the experimental spectrum is taken as being the sum of all branch scores, and this sum may be used as a correlation score. Typically the highest scoring branches are returned as candidate matches.

Protein ID Module

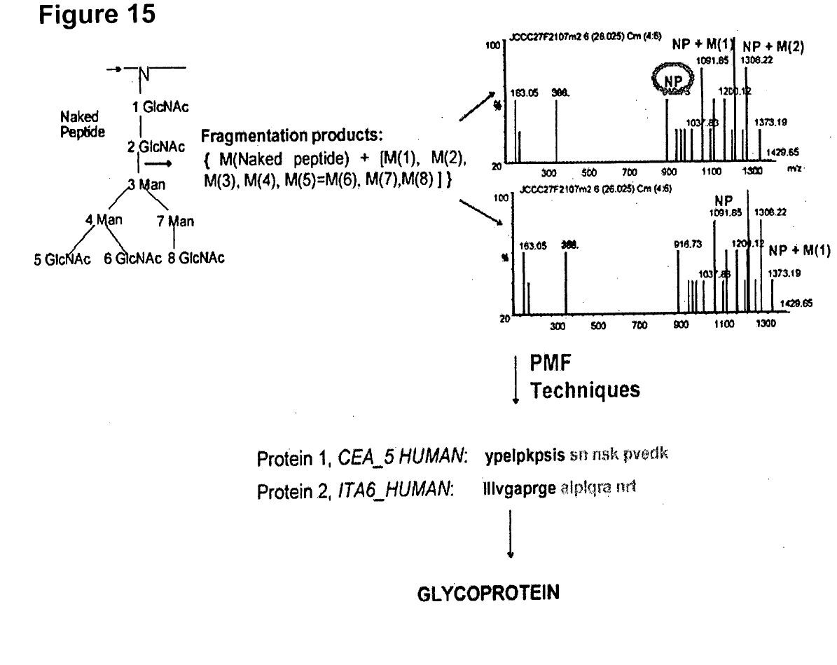

It is generally desirable to identify the parent protein from which a glycopeptide originates. If the deglycosylated peptide mass can be determined, for example from Sugar Structure Identification Module analysis of a candidate glycopeptide's spectra, said mass can be used to search a database of known peptides for a match using Peptide Mass Fingerprinting (PMF) Techniques. This process is illustrated in FIG. 15.

Preferably a database of known peptides can be generated by obtain a list of proteins, such as human proteins, from a publicly available database (e.g. GenBank), or from a list suggested by the user (such as by NCBI accession number), and treated appropriately for comparison to the mass spectrum at hand, e.g. in silico tryptic digestion of proteins to be matched to peptides from a trypsinized sample. To reduce the number of likely false positives when working with N-linked glycopeptides the subset of peptides containing the N-linked core NXS/T, wherein “N” represents asparagine, “X” represents any amino acid, “S” represents serine, and “T” represents threonine, may be exclusively selected from the database for comparison. For each glycopeptide for which the naked peptide was identified, search the database can be searched for candidate matching peptides and their protein(s) of origin.

In sum, this module provides a method for identifying the parent protein of a glycopeptide, comprising: a) selecting a glycopeptide spectrum for analysis; b) determining the naked peptide; c) determining the mass of the naked peptide; d) obtaining an appropriate database of peptides; e) and, matching the peptide to a peptide of known parentage from the database by peptide mass fingerprinting, thereby identifying the parent protein.

### EXAMPLES

The following examples are presented for illustrative purposes only and are not intended, nor should they be construed, as limiting the invention in any way. Those skilled in the art will recognize that variations on the following can be made without exceeding the spirit or scope of the invention.

### Example 1

### Sample Preparation, Survey Scan, and Spectra Generation

Plasma membrane enriched extracts were obtained by immunoaffinity selection (see U.S. Utility application Ser. No. 10/251,379, US Patent Publication Number 2003/0064359, published on Apr. 3, 2003, the whole of which is incorporated herein by reference), and the protein extracts were separated by gel electrophoresis. Bands were excised and digested with trypsin and analyzed by nano LC-MS at a flow rate of 400 nL/min on a Micromass Q-TOF Ultima (Milford, Mass.)—the “survey scan”. The eluting peptides were ionized by electrospray and the peptide ions were automatically selected and fragmented in a data dependent acquisition mode. The resulting MS/MS spectra were subsequently subject to database searching for protein identification with Mascot (Matrix Science, London, UK).

### Example 2

### Survey Scan Analysis

Survey scan data obtained, such as in Example 1, provides ion count peaks for the biomolecules represented therein, including the m/z values of the peptides and peptidic fragments present. Characteristic distributions of peaks separated by mass differences within a reasonable error limit equivalent to the masses of monosaccharides allow the precursors associated with those peaks to be designated as glycoforms, or potential glycoforms by use of a Survey Scan Analysis Module. Designated glycoforms or candidate glycoforms may then be selected for a further round of MS/MS, such as through an inclusion list on the current sample or a subsequent sample.

### Example 3

### Glycopeptide Identification

MS/MS data sets were generated to test the behavior of the N-GIA Gylcopeptide Identification Module on 3 types of data sets: peptides, validated glycopeptides and random peptides. The peptide data set was generated by including the data of MS/MS spectra which received a minimum Mascot (Matrix Science) of 35 indicating high quality peptide spectra. The glycopeptide data set was generated by pooling the MS/MS information from previously validated glycopeptides and the random peptide set consisted of MS/MS spectra that were unassigned by Mascot and likely non-peptidic.

When run with the Glycosylation Detection Module, the glycopeptide score distribution was shown to vary between data sets (FIG. 11a). The glycopeptides were shown to have scores distributed between 0.9 and 2.4 with the mean glycosylation score at 1.57. These scores were shown to be much higher than that of the validated peptides, which demonstrated a mean glycosylation score of 0.26 (FIG. 11a). No overlap between these two distributions was observed. In between the peptide and glycopeptide distributions were the scores of the random peptide sample, which demonstrated slightly higher glycosylation scores than the peptidic set (FIG. 11a). The slight increase in glycosylation scores can be attributed to some spectra which may randomly contain some characteristics of glycopeptides such as significant peaks and/or sparse areas. Thus, it was observed that the Glycopeptide Detection Module is selective enough to correctly assign high scores to true glycopeptides and low scores to non-glycopeptides including spectra which may arbitrarily contain some of the features of the glycopeptide model.

To verify the results of the glycopeptide score distribution, the same data were evaluated for their peptide coverage. Peptide Coverage Score is a measure of the ‘peptidic’ quality of a spectrum. The goal of the score is to indicate the proportion of the spectra that can be de novo sequenced by manual inspection. To derive this score, the number of amino acids in the spectra is calculated by observing the presence of two significant peaks separated by the mass of an amino acid. A coverage score is derived based on the percentage of the spectrum that is spanned by amino acids. The peptide coverage scores for the 3 data sets were shown to be distributed as illustrated in FIG. 11b.

Peptide coverage scores were shown to have an opposite trend to the glycosylation scores. The highest scores were assigned to the peptide data set (mean 94.5) and the lowest scores for the glycopeptide data set (mean 19.2). As was observed in the glycosylation score distribution, there was no overlap between the distributions of the glycosylated and peptide distributions. As well, the scores for the random peptide set (mean coverage score of 56.8) lie in between the glycopeptides and the peptide scores. Glycopeptide misclassifications would result in more significant overlap between the distributions of the coverage scores for the glycopeptides and the peptides. The peptide coverage score distribution provides further verification of effectiveness of the Glycopeptide Identification Module as a glycopeptide classifier.

The Glycopeptide Identification Module of N-GIA was also tested on a sample processed per Example 1, which resulted in the obtaining of 17295 MS/MS fragmentation spectra, of which 38 were known glycopeptide spectra (true positives). The spectra were examined using a Glycopeptide Identification Module. The Glycopeptide Identification Module rapidly and accurately detected glycosylated spectrum from MS/MS data: all 38 glycopeptide spectra were identified (false negative rate of 0), as well as 6 false positives (0.03% error rate).

Analysis was further tested on a sample of 94648 spectra. From this experiment, the Glycopeptide Identification Module and was able to identify 97% (at threshold 0.9) of the true positives in the sample which equal roughly 0.2% of all spectra in the sample. When run on a 4 CPU, 8 gigahertz processor, the Glycopeptide Identification Module was able to process 10000 spectra per minute.

### Example 4

### Glycan Analysis

Both the Full and Path models of glycan fragmentation were implemented in C++ and run on test sets of glycopeptides. Spectra were pooled manually and separated into two sets depending on whether the glycan was classified as being complex or oligomannose. The oligomannose data set consisted of 15 spectra and the complex data set consisted of 12 spectra. The accuracy of the program to correctly identify the starting point of the glycan in the glycopeptide spectrum, the peak representing the naked peptide, was assessed by observing the percentage of correct naked peptide masses identified within a margin of one monosaccharide mass. In addition, the correct charge of the naked peptide had to be correctly identified.

In general, both the Full and Path models performed equally well in determining the correct naked peptide and the results were not contingent on the type of glycan analyzed. Specifically, the oligomannose spectra set produced 12/15 of the correct naked peptides and in the complex data set, 11/12 of the naked peptides were correctly identified. In addition, for identical glycopeptides analyzed on different machines or for glycoforms (for example, the same glycan with the higher mass glycopeptide containing one extra Hexose residue), the same naked peptide was returned. Of the incorrectly assigned naked peptides, 75% were the result of a false charge assignments for the naked peptides in the oligomannose data sets, and 100% in the complex data set. If the isotopic distributions were not well resolved, there was some ambiguity regarding the peak charge. As a result of an incorrect charge assignment to the naked peptide, all subsequent peaks were incorrectly assigned as well. Future implementations can take this into account.

The performance of the Glycan Analysis Module was also evaluated on its ability to return a correct monosaccharide composition and glycan structure. To evaluate the effectiveness of each fragmentation model in the elucidation of glycan structure, two main criteria were used. The first criteria examined the number of matched peaks found in the spectrum versus the number of observed glycan fragments in the spectrum. For each glycopeptide in the complex and oligomannose data sets, the structure of the glycan was examined and the peaks representing the various partial fragments and their charges were identified. These observed peaks were matched against those correctly identified (in terms of m/z and charge) by the Glycan Analysis Module. This ratio of matched peaks to observed peaks provides an assessment of the ability of the Module to correctly identify the partial fragments in the spectrum and thus to report the saccharide composition of the glycans. The other main criteria used to evaluate the match was a qualitative assessment of the similarity of the structure of the top hits to the structure of the glycan represented in the spectrum.

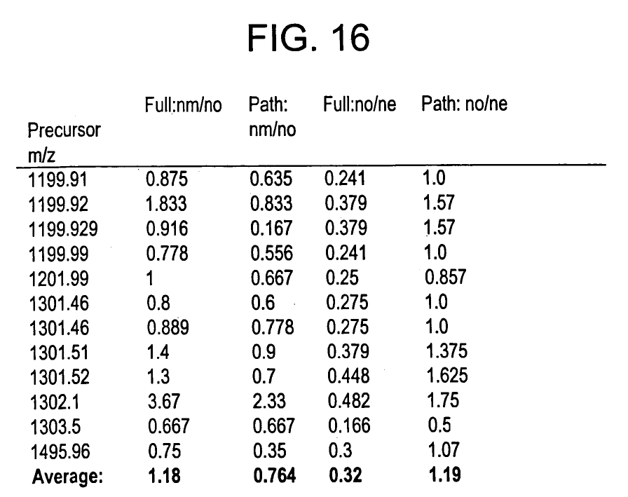

The results for each spectrum of the complex data set are shown in FIG. 16. In general, the ratio of observed peaks to predicted peaks in the Full Model was found to be approximately 0.32 suggesting that for the majority of complex N-glycans only a small number of predicted peaks are observed. This surplus in theoretical fragments is partially responsible for random peak matches obtained by the Full Model. The same ratio in the Path Model was found to be 1.19 indicating that all predicted peaks are observed. Furthermore this ratio shows that in several cases there are more peaks observed than predicted. This result can be attributed to the fact that the Path Model does not take into account branch combinations which contributes to a small number of observed peaks is quite small.

In FIG. 16, the ratio of matched peaks to observed peaks is also shown for the complex glycans using both the Full and Path models. The average value of n_{matched}/n_{observed} in the Full Model was computed to be 1.18 and that of the Path Model was found to be 0.76, suggesting that the Full Model was capable of identifying more partial glycan fragments in the spectrum. However, since the ratio in the Full Model is greater than 1, this result also suggests that the Full Model is matching peaks that are not observed. As discussed above, the Full Model produces many more peaks than those observed in the spectrum. This surplus of peaks increases the likelihood of matching theoretical fragments randomly. Random peak matches were noted in 11.5% of the Full Model matches and 7% of Path Model matches. Closer examination of these false peak assignments reveals that they can often be attributed to factors such as matching noise peaks or peaks representing water loss. In most cases however, the reason for false assignments was incorrect charge assignment. In general, although the Path Model was able to match less peaks, the structures returned by both the Full and Path models were comparable.

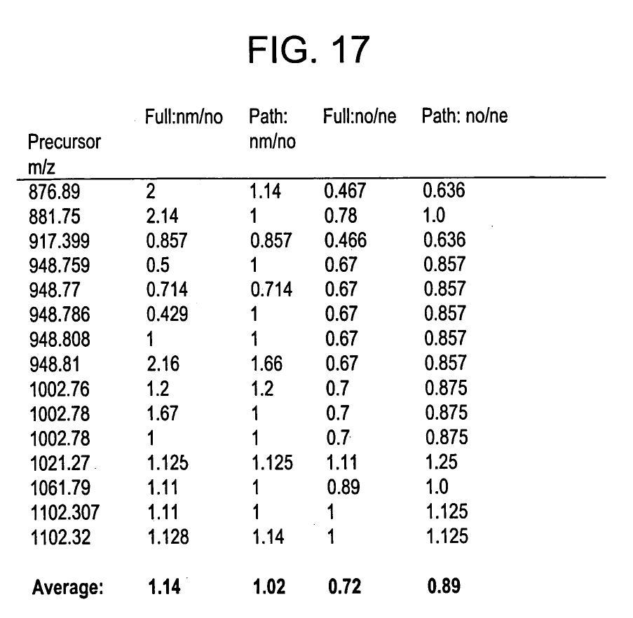

Compared to the analysis of complex glycans, the discrepancy in the ratio of observed peaks to theoretical peaks in both models of glycan fragmentation with the oligomannose data set was much smaller; ratios of 0.72 and 0.89 were observed for the Path and Full models respectively (see FIG. 17). This smaller discrepancy was expected since there is less variability in monosaccharide composition, the size of the set of peaks produced by the Full Model is generally smaller than that produced for complex glycans. Thus, for oligomannose glycans, both fragmentation models performed similarly. The average ratio of matched peaks to observed peaks in oligomannose glycans was found to be 1.14 and 1.02 in the Full and Path models respectively. In all spectra of the oligomannose data, the observed peaks were correlated to partial glycan fragments in the spectra. Compared to complex glycans, there is less discrepancy in the ratio of matched to observed peaks between the two models.

When the Path Model of fragmentation was used in the analysis of the oligomannose glycans, in all cases the correct structure was determined. The Full Model of fragmentation was found to perform worse than the Path model on oligomannose sugars. Out of all the oligomannose spectra, 46% of spectra were assigned oligomannose structures among the top 5 hits returned by the Glycan Analysis Module. Although in the majority of oligomannose glycans suitable structures were returned, in 20% of cases complex glycans were returned instead of oligomannose structures. It is important to note however, that even when an incorrect structure was returned, many of the peak assignments were correct. The difference in the performance can be partially attributed to the fact that the large number of peaks produced by the Full Model were matched to noise. In general, an average of 2 spectra per minute were analyzed by the Path Model.

### Example 5

### N-GIA

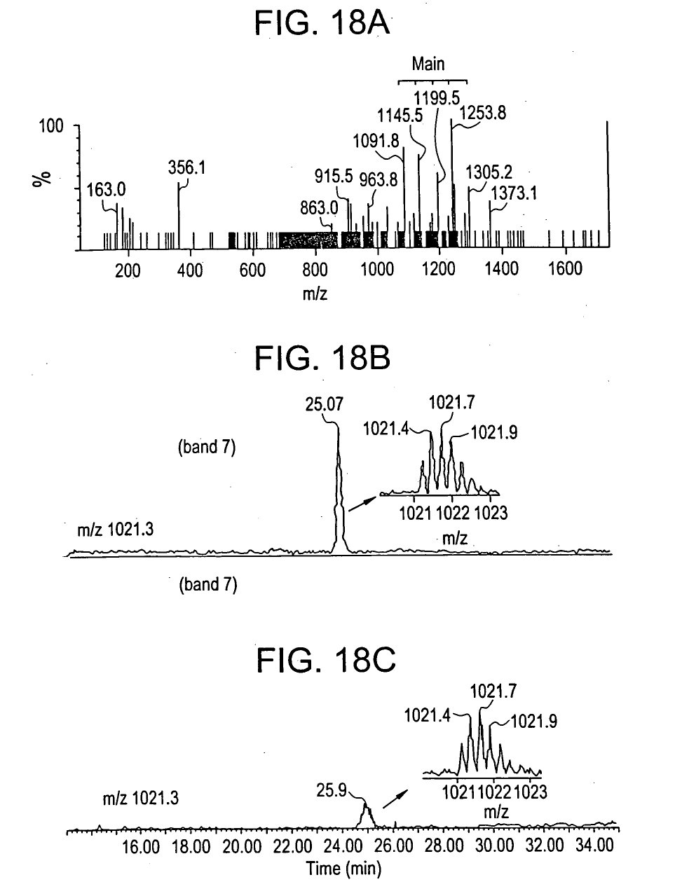

The N-GIA was integrated into a high throughput proteomics pipeline to assist in differential glycopeptide expression studies in normal and tumor tissue of patients afflicted with colon cancer. After MS/MS spectra for the samples were acquired, they were run through both the Glycopeptide Identification Module and the Glycan Analysis Module. For a glycopeptide identified by the Glycopeptide Identification Module at m/z 1021.16, the MS survey scans in this m/z range were analyzed in both the normal and tumor tissues of a particular patient. Analysis of the survey scans revealed that the glycopeptide was upregulated in tumor tissue as illustrated in the large peak at m/z 1021.16 in the tumor sample (FIG. 18b) versus the smaller peak at the same m/z in the normal sample (FIG. 18c).

To match the differentially expressed glycopeptide to its parent protein, the Glycan Analysis Module was used. Further, the Glycan Analysis Module was enhanced to detect other post-translational modifications (PTMs) and combinations of PTMs. For this glycopeptide, the Glycan Analysis Module suggested an oligomannose glycan structure (HexNAc₂Hex₉) naked peptide mass of 915.57. The Protein ID Module used takes in as input the mass of the naked peptide and attempts to match this mass to all tryptic peptides of the NCBi database containing the NXS/T sequon common to all N-linked glycoproteins. Using the Protein ID Module, the naked peptide of the differentially expressed peptides was matched to the protein Carcinoembryonic Antigen (CEA5 HUMAN), a known glycoprotein marker for cancer.

This example illustrates the capabilities of N-GIA to facilitate differential expression and drug target discovery in glycomics and proteomics.

Other Embodiments

Although certain presently preferred embodiments of the invention have been described herein, it will be apparent to those of skill in the art to which the invention pertains that variations and modifications of the described embodiment may be made without departing from the spirit and scope of the invention. Those skilled in the art will recognize, or be able to ascertain using no more than routine experimentation, many equivalents to the specific embodiments of the invention described herein. Such equivalents are intended to be encompassed by the following claims. And accordingly, it is intended that the invention be limited only to the extent required by the following claims and the applicable rules of law.

All patents, patent applications, and publications referenced herein are hereby incorporated by reference.

We claim:

1. A method for determining glycoforms in mass spectrometry survey scan data, said method comprising the steps of:
a) providing a biological sample comprising a plurality of biomolecules;
b) generating a plurality of ions of said biomolecules;
c) performing mass spectrometry measurements on the plurality of ions, thereby obtaining ion count peaks for the biomolecules; and
d) identifying distributions of glycoform ion count peaks by monosaccharide differences, thereby determining the presence of glycoforms in the biological sample.

2. The method of claim 1, wherein one or more of the identified glycoforms is selected for MS/MS acquisition.

3. A computer implemented method for determining glycoforms in mass spectrometry survey scan data, said method comprising the steps of:
a) inputting mass spectrometry data comprising ion counts for a plurality of biomolecules into a computer; and
b) identifying distributions of glycoform ion count peaks by monosaccharide differences, thereby determining the presence of glycoforms in the biological sample.

4. The computer implemented method of claim 3, wherein one or more of the identified glycoforms is selected for MS/MS acquisition.

5. A computer-readable memory having stored thereon a program for determining glycoforms in mass spectrometry survey scan data comprising:
a) computer code that receives as input mass spectrometry data comprising ion counts for a plurality of biomolecules; and
b) computer code that identifies distributions of glycoform ion count peaks by monosaccharide differences, thereby determining the presence of glycoforms in the biological sample.

6. The computer-readable memory of claim 5, wherein one or more of the identified glycoforms is selected for MS/MS acquisition.

7. A computer system for determining glycoforms in mass spectrometry survey scan data comprising a processor and a memory coupled to said processor, said memory encoding one or more programs, said one or more programs causing said processor to perform a method comprising the steps of:
a) inputting mass spectrometry data comprising ion counts for a plurality of biomolecules; and
b) identifying distributions of glycoform ion count peaks by monosaccharide differences, thereby determining the presence of glycoforms in the biological sample.

8. The computer system of claim 7, wherein one or more of the identified glycoforms is selected for MS/MS acquisition.

9. A method for displaying information on glycoforms in a biological sample to a user, said method comprising the steps of:
a) inputting mass spectrometry data comprising ion counts for a plurality of biomolecules into a computer;
b) identifying distributions of glycoform ion count peaks by monosaccharide differences, thereby determining the presence of glycoforms in the biological sample; and
c) displaying information on glycoforms in the biological sample to a user.

10. The method of claim 9, further comprising the step of (d) storing the distributions of glycoform ion count peaks in a memory.

11. The method of claim 9, wherein one or more of the identified glycoforms is selected for MS/MS acquisition.

12. A method for determining glycopeptides in mass spectrometry MS/MS data, said method comprising the steps of:
a) providing a biological sample comprising a plurality of biomolecules;
b) generating a plurality of ions of said biomolecules;
c) performing mass spectrometry measurements on the plurality of ions, thereby obtaining MS/MS spectra for one or more biomolecules;
d) assessing one or more MS/MS spectra for the presence of oxonium ions, a low peak density area, and monosaccharide loss;
e) scoring the spectra;
f) comparing the spectra scores to a glycosylation threshold, and
g) classifying spectra as glycopeptide spectra or not based on the results of the comparison of spectra scores to a glycosylation threshold.

13. The method of claim 12, wherein said biomolecules are from an isolated tissue type.

14. The method of claim 12, wherein said biomolecules are from an isolated cell type.

15. The method of claim 12, wherein said biomolecules are from an isolated organelle.

16. The method of claim 15, wherein said organelle is selected from the group consisting of mitochondria, chloroplasts, ER, Golgi, endosomes, lysosomes, phagosomes, peroxisomes, nucleus, plasma membrane, and secretory vesicles.

17. The method of claim 12, wherein said biomolecules are unlabeled biomolecules.

18. The method of claim 12, wherein said biomolecules are underivatized biomolecules.

19. The method of claim 12, wherein said biomolecules are both unlabeled and underivatized.

20. The method of claim 12, wherein said biomolecules are cleaved biomolecules.

21. The method of claim 20, wherein said biomolecules are cleaved with an enzyme.

22. The method of claim 21, wherein said enzyme is trypsin.

23. The method of claim 12, wherein said method further comprises separating the plurality of biomolecules prior to step (b).

24. The method of claim 23, wherein separation is carried out by chromatography, electrophoresis, immunoisolation, or centrifugation.

25. The method of claim 23, wherein carbohydrate-containing biomolecules are not selectively isolated from the plurality of biomolecules.

26. The method of claim 23, wherein glycoproteins are not selectively isolated from the plurality of biomolecules.

27. The method of claim 23, wherein glycopeptides are not selectively isolated from the plurality of biomolecules.

28. The method of claim 12, wherein said biological sample includes one or more internal standards.

29. The method of claim 28, wherein retention time is corrected using said internal standard(s).

30. A computer implemented method for determining glycopeptides in mass spectrometry MS/MS data, said method comprising the steps of:
a) inputting mass spectrometry data comprising ion counts for a plurality of biomolecules into a computer;
b) assessing one or more MS/MS spectra for the presence of oxonium ions, a low peak density area, and a pentasaccharide core;
c) scoring the spectra;
d) comparing the spectra scores to a glycosylation threshold; and
e) classifying spectra as glycopeptide spectra or not based on the results of the comparison of spectra scores to a glycosylation threshold.

31. A computer-readable memory having stored thereon a program for determining glycopeptides in mass spectrometry MS/MS data comprising:
a) computer code that receives as input mass spectrometry data comprising ion counts for a plurality of biomolecules;
b) computer code that assesses one or more MS/MS spectra for the presence of oxonium ions, a low peak density area, and a pentasaccharide core;
c) computer code that scores the spectra;
d) computer code that compares the spectra scores to a glycosylation threshold; and
e) computer code that classifies spectra as glycopeptide spectra or not based on the results of the comparison of spectra scores to a glycosylation threshold.

32. A computer system for determining glycopeptides in mass spectrometry MS/MS data comprising a processor and a memory coupled to said processor, said memory encoding one or more programs, said one or more programs causing said processor to perform a method comprising the steps of:
a) inputting mass spectrometry data comprising ion counts for a plurality of biomolecules;
b) assessing one or more MS/MS spectra for the presence of oxonium ions, a low peak density area, and a pentasaccharide core;
c) scoring the spectra;
d) comparing the spectra scores to a glycosylation threshold; and
e) classifying spectra as glycopeptide spectra or not based on the results of the comparison of spectra scores to a glycosylation threshold.

33. A method for displaying information on glycopeptides in a biological sample to a user, said method comprising the steps of:
a) inputting mass spectrometry data comprising ion counts for a plurality of biomolecules into a computer;
b) assessing one or more MS/MS spectra for the presence of oxonium ions, a low peak density area, and a pentasaccharide core;
c) scoring the spectra;
d) comparing the spectra scores to a glycosylation threshold;
e) classifying spectra as glycopeptide spectra or not based on the results of the comparison of spectra scores to a glycosylation threshold; and
f) displaying information on glycopeptides in the biological sample to a user.

34. The method of claim 33, wherein step (g) further comprises storing one or more of the following in a memory: oxonium ions present in an MS/MS spectra, low peak density areas in an MS/MS spectra, pentasaccharide cores present in an MS/MS spectra; spectra scores, and spectra classifications.

35. A method for determining the most likely naked peptide for a glycopeptide spectrum from a group of candidate naked peptides, comprising:
a) providing a group of candidate naked peptides for a glycopeptide spectrum;
b) applying theoretical sugar fragments to the candidate naked peptides;
c) determining correlation scores for the resultant candidate glycopeptides; and
d) determining the highest scoring match from the group of candidate glycopeptides, from which the carbohydrate portion indicates the optimal sugar structure, and the peptidic portion indicates the most likely naked peptide.

36. A computer implemented method for determining the most likely naked peptide for a glycopeptide spectrum from a group of candidate naked peptides, said method comprising the steps of:
a) providing a group of candidate naked peptides for a glycopeptide spectrum;
b) applying theoretical sugar fragments to the candidate naked peptides;
c) determining correlation scores for the resultant candidate glycopeptides; and
d) determining the highest scoring match from the group of candidate glycopeptides, from which the carbohydrate portion indicates the optimal sugar structure, and the peptidic portion indicates the most likely naked peptide.

37. A computer-readable memory having stored thereon a program for determining the most likely naked peptide for a glycopeptide spectrum from a group of candidate naked peptides comprising:
a) computer code that receives as input a group of candidate naked peptides for a glycopeptide spectrum;
b) computer code that applies theoretical sugar fragments to the candidate naked peptides;
c) computer code that determines correlation scores for the resultant candidate glycopeptides; and
d) computer code that determines the highest scoring match from the group of candidate glycopeptides, from which the carbohydrate portion indicates the optimal sugar structure, and the peptidic portion indicates the most likely naked peptide.

38. A computer system for determining the most likely naked peptide for a glycopeptide spectrum from a group of candidate naked peptides comprising a processor and a memory coupled to said processor, said memory encoding one or more programs, said one or more programs causing said processor to perform a method comprising the steps of:
a) inputting a group of candidate naked peptides for a glycopeptide spectrum;
b) applying theoretical sugar fragments to the candidate naked peptides;
c) determining correlation scores for the resultant candidate glycopeptides; and
d) determining the highest scoring match from the group of candidate glycopeptides, from which the carbohydrate portion indicates the optimal sugar structure, and the peptidic portion indicates the most likely naked peptide.

39. A method for displaying information on the most likely naked peptide for a glycopeptide spectrum from a group of candidate naked peptides to a user, said method comprising the steps of:
a) inputting a group of candidate naked peptides for a glycopeptide spectrum;
b) applying theoretical sugar fragments to the candidate naked peptides;
c) determining correlation scores for the resultant candidate glycopeptides;
d) determining the highest scoring match from the group of candidate glycopeptides, from which the carbohydrate portion indicates the optimal sugar structure, and the peptidic portion indicates the most likely naked peptide; and
e) displaying information on the most likely naked peptide for a glycopeptide from a group of candidate naked peptides to a user.

40. The method of claim 39, further comprising the step of (f) storing one or more of the following in a memory: a glycopeptide spectrum, candidate peaks and their intensities, correlation scores, the most likely naked peptide for the glycopeptide, and the optimal sugar structure.
